(19) United States
(12) Patent Application Publication
(10) Pub. No.: US 2025/0387892 A1
(43) Pub. Date: Dec. 25, 2025

(54) ELECTRIC TOOL AND STORAGE DEVICE THEREFOR

(71) Applicant: MetaSee LLC, PEARLAND, TX (US)

(72) Inventors: Jiabiao Li, PEARLAND, TX (US); Banghao Hu, PEARLAND, TX (US)

(21) Appl. No.: 19/245,181

(22) Filed: Jun. 20, 2025

(30) Foreign Application Priority Data
Jun. 25, 2024 (CN) 202410827572.0
Aug. 29, 2024 (CN) 202411201910.6

(51) Int. Cl. B25F 1/02; B25F 5/00; B25F 5/02

(52) U.S. Cl. CPC B25F 1/02; B25F 5/001; B25F 5/02

(57) ABSTRACT

An electric tool includes: a housing assembly including a housing body and an operation portion integrally connected with the housing body; a driving mechanism connected to the housing assembly and including a motor and a transmission shaft connected to and driven by the motor; and a control module arranged within the housing assembly and comprising a controller and a sensing element that is electrically connected to the controller. The motor is electrically connected to the controller. The sensing element is arranged at an inner side of the operation portion. The sensing element is to detect a user operation on the operation portion and output a signal to the controller, and the controller is to control the motor in response to the signal output by the sensing element.

### CROSS REFERENCE TO RELATED APPLICATIONS

This application claims priority to Chinese Patent Application Nos. CN 202411201910.6, filed Aug. 29, 2024, and CN 202410827572.0, filed Jun. 25, 2024, which are hereby incorporated by reference herein as if set forth in their entirety.

### TECHNICAL FIELD

The present disclosure generally relates to electric tools, and in particular relates to an electric tool with a switch and a storage device for receiving the electric tool.

### BACKGROUND

Electric rotary tools are widely used in various industries due to their high efficiency, portability, and ease of operation. In conventional designs, the housing of an electric rotary tool is provided with an opening, and the tool includes a button installed through this opening. By pressing the button, users can adjust the operating parameters of the electric rotary tool, such as controlling its rotational speed, power on/off, and other functional settings. Although conventional electric tools can meet basic operational requirements, there remains a useful and necessary demand for new electric tools—particularly those with enhanced dustproof/waterproof performance.

Moreover, for electric tools that include multiple accessories—such as screwdrivers with interchangeable bits, power saws with assorted blades, or electric grinders with various attachments—users often struggle to locate specific parts, and the accessories are prone to being misplaced. This significantly impacts the user experience, highlighting the urgent need for a dedicated storage solution to organize these components.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of a driving module of an electric tool according to one embodiment.

FIG. 2 is an isometric exploded view of the driving module of FIG. 1.

FIG. 3 is a planar view showing the inertial detail of the driving module of FIG. 1.

FIG. 4 is a schematic view of a functional module of the electric tool according to one embodiment.

FIG. 5 is a schematic view showing the arrangement of two conductive contacts in contact with a conductive ring according to one embodiment.

FIG. 6 is a schematic view showing the arrangement of two conductive contacts in contact with the conductive ring according to another embodiment.

FIG. 7 is an isometric partially exploded view of the driving module of FIG. 1 with certain components omitted.

FIG. 8 is an isometric partially exploded view of the driving module of FIG. 1 with certain components omitted.

FIG. 9 is a schematic block diagram of the driving module of FIG. 1.

FIG. 10 is an enlarged view of a portion A in FIG. 2.

FIG. 11 is a schematic flowchart of a control method for controlling the electric tool.

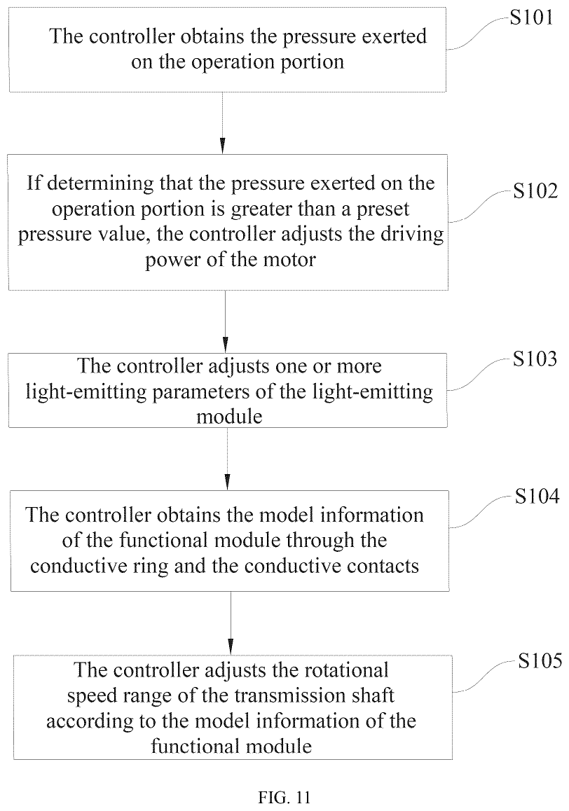

FIG. 12 is a schematic view of a storage device for accommodating the main body of an electric tool according to one embodiment.

FIG. 13 is a planar sectional view of the storage device of the storage device taken along a line A in FIG. 12.

FIG. 14 is an enlarged view of a portion A1 in FIG. 13.

FIG. 15 is a schematic view of a storage device for accommodating the main body of an electric tool according to another embodiment.

FIG. 16 is a schematic view of a storage device for accommodating the main body of an electric tool according to yet another embodiment.

FIG. 17 is a schematic view of the storage device of FIG. 12 with certain components omitted.

FIG. 18 is a planar sectional view of the storage device taken along a line B in FIG. 15.

FIG. 19 is a planar sectional view of the storage device taken along a line C in FIG. 16.

FIG. 20 is a planar sectional view of the storage device taken along a line D in FIG. 12.

FIG. 21 is a planar sectional view of the storage device taken along a line E in FIG. 15.

FIG. 22 is an enlarged view of a portion A2 in FIG. 13.

FIG. 23 is an enlarged view of a portion C1 in FIG. 19.

FIG. 24 is an enlarged view of a portion C1 in FIG. 19.

FIG. 25 is a portion of a cross sectional view of the storage device taken along a line F in FIG. 163

FIG. 26 is an isometric view of an electric tool according to one embodiment.

FIG. 27 is a planar sectional view of the electric tool taken along a line A′ in FIG. 26.

FIG. 28 is an isometric view of an electric tool according to another embodiment.

FIG. 29 is a planar sectional view of the electric tool taken along a line C′ in FIG. 28.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

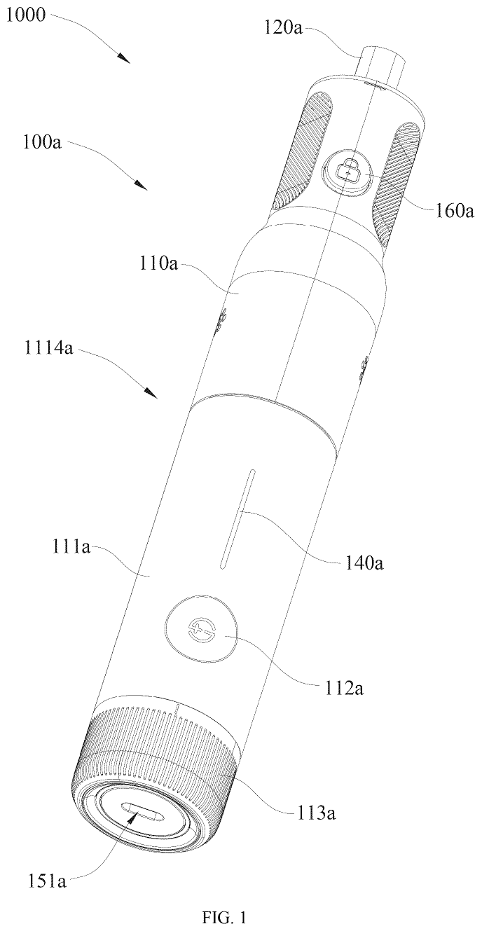

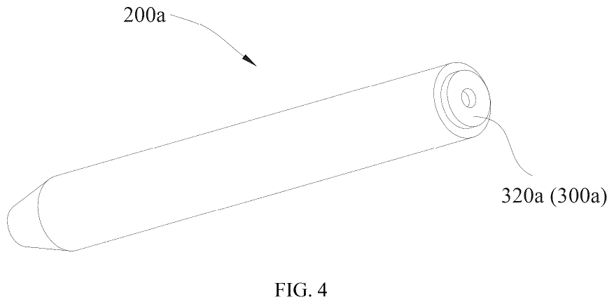

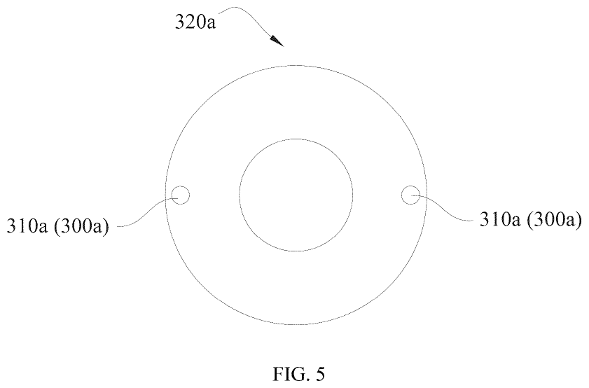

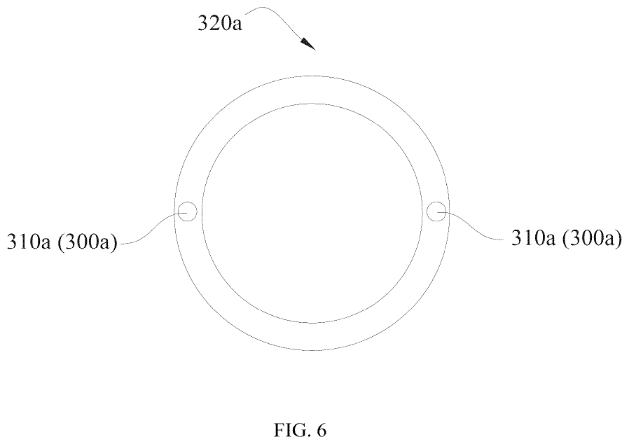

Referring to FIGS. 1-6, in one embodiment, an electric tool 1000 includes a driving module 100a and a functional module 200a. The functional module 200a is detachably connected to the driving module 100a, and the functional module 200a includes a functional head, which is detachably connected to a transmission shaft 122a of the driving module 100a. The functional head is of various types, and any type of functional head can be detachably connected to a second end 1222a of the transmission shaft 122a of the driving module 100a. The functional head can be an engraving bit, a drill bit, a cutting tool, a grinding head, and a polishing bit, etc. For example, the functional head is a grinding head. The functional module 200a enhances the capabilities of the electric tool, expanding its range of applications. The motor 121a of the driving module 100a can drive the functional head to perform operations such as drilling or cutting. The motor 121a and the transmission shaft 122a will be described in detail below. In one embodiment, the electric tool 1000 may feature a unitary elongated cylindrical form factor, thereby improving the user experience and the aesthetics of the electric tool 100.

In one embodiment, the driving module 100a includes a housing assembly 110a, a driving mechanism 120a and a control module 130a. The housing assembly 110a can be integrally formed. The housing assembly 110a may include a housing body 111a and an operation portion 112a. The operation portion 112a is integrally connected with the housing body 111a, effectively preventing foreign matter (e.g., dust, water, or other external contaminants) from entering the housing assembly 110a and affecting the normal operation of the driving mechanism 120a and the control module 130a, effectively improving the dustproof and waterproof performance of the driving module 100a, and thereby extending the service life of the driving module 100a. The operation portion 112a is shaped and sized to match the finger-pulp shape of a human hand, which facilitates a user to control the working state of the driving module 100a while improving the aesthetics of the driving module 100a.

Referring to FIG. 1, in one embodiment, the housing body 111a includes a handheld portion 1114a adapted for gripping, and the operation portion 112a is arranged at a position of the housing assembly 110a away from the handheld portion 1114a to prevent a user from accidentally touching the operation portion 112a when grasping the driving module 100a during use of the driving module 100a. The driving mechanism 120a includes a motor 121a and a transmission shaft 122a. The motor 121a can drive the transmission shaft 122a to rotate around its own axis. The motor 121a is arranged in the housing assembly 110a. The transmission shaft 122a has a first end 1221a and a second end 1222a opposite to each other. The first end 1221a is arranged in the housing assembly 110a and connected to and driven by the motor 121a. The second end 1222a passes through the housing assembly 110a and is used to output torque.

The control module 130a is arranged in the housing assembly 110a. The control module 130a includes a controller 131a and a sensing element 132a electrically connected to each other. The motor 121a of the driving mechanism 120a is electrically connected to the controller 131a. The sensing element 132a is arranged at and faces the inner side of the operation portion 112a. The sensing element 132a is to detect a user's operation on the operation portion 112a and output a signal to the controller 131a. In one embodiment, the sensing element 132a is a pressure sensor or a temperature sensor. The following description takes the sensing element 132a as a pressure sensor as an example. The controller 131a responds to the output signal from the sensing element 132a and controls the motor 121a accordingly. For example, the controller 131a can control the motor 121a to drive the transmission shaft 122a at a corresponding rotational speed.

In another embodiment, the controller 131a can further control the activation and deactivation of the motor 121a. It should be noted that the term “corresponding rotational speed” as used herein encompasses, but is not limited to: the rational speed required for the transmission shaft 122a when the driving module 100a is used for engraving operations; the rational speed required for the transmission shaft 122a when the driving module 100a is used for grinding; the rational speed required for the transmission shaft 122a when the driving module 100a is used for drilling; the rational speed required for the transmission shaft 122a when the driving module 100a is used for polishing; and the rational speed required for the transmission shaft 122a when the driving module 100a is used for cutting. In one embodiment, the driving module 100a further includes an inner housing 114a, which is arranged in the housing body 111a, and the driving mechanism 120a and the control module 130a are arranged in the inner housing 114a. The inner housing 114a can provide protection for the driving mechanism 120a and the control module 130a.

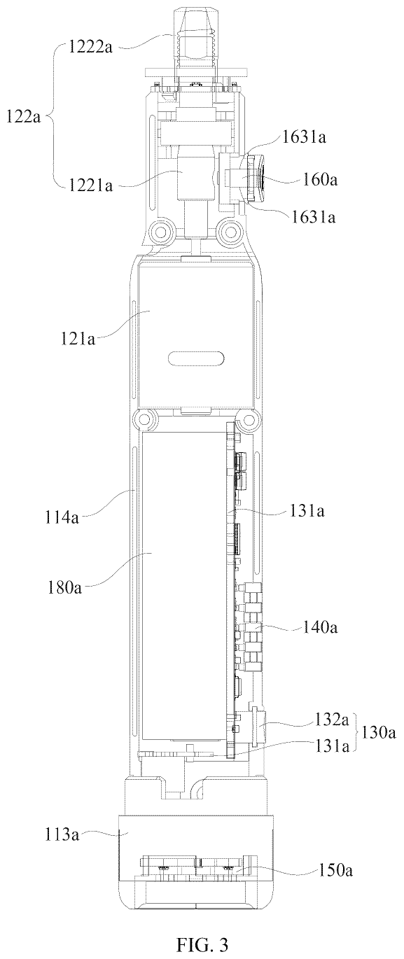

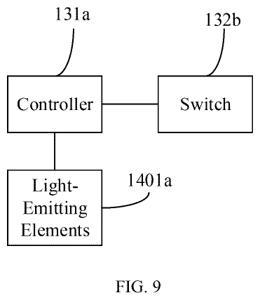

Referring to FIGS. 1 and 3, the driving module 100a further includes a light-emitting module 140a that includes one or more light-emitting elements 1401a (see FIG. 9). The light one or more light-emitting elements 1401a are electrically connected to the controller 131a. The controller 131a is to adjust one or more light emitting parameters of the light-emitting elements 1401a according to the rotational speed of the transmission shaft 122a.

In an embodiment where the light-emitting module 140 includes only one light-emitting element, the light-emitting element can be a light strip 141a. The illumination length of the light-emitting element corresponds to the rotational speed of the transmission shaft 122a. Specifically, the light strip 141a is configured to display different illumination lengths, and the light-emitting module 140a is configured to make the illumination length of the light strip 141a correspond to the rotational speed of the transmission shaft 122a. That is, the higher the rotational speed of the transmission shaft 122a, the longer the illumination length displayed by the light strip 141a, and the lower the rotational speed of the transmission shaft 122a, the shorter the illumination length displayed by the light strip 141a.

In another embodiment, the light-emitting module 140a includes a number of light-emitting lamps, each light-emitting lamp being arranged at intervals along a straight line. In one embodiment, the light-emitting module 140a is configured such that the number of illuminated lamps corresponding to the rotational speed of the transmission shaft 122a. That is, the higher the rotational speed of the transmission shaft 122a, the greater the number of illuminated lamps; the lower the rotational speed of the transmission shaft 122a, the fewer the number of illuminated lamps. In another embodiment, the light-emitting module 140a is provided with a starting position, and the light-emitting lamps are arranged linearly and spaced apart from the starting position. Illumination of a lamp located farther from the starting position corresponds to a higher rotational speed of the transmission shaft 122a, whereas illumination of a lamp located closer to the starting position corresponds to a lower rotational speed of the transmission shaft 122a.

In another embodiment, the light-emitting module 140a can display different colors, and the light-emitting component 140a is configured to display different colors to correspond to different rotational speeds of the transmission shaft 122a. For ease of description, it is defined that when the light-emitting module 140a displays blue, it corresponds to a first rotational speed of the transmission shaft 122a; when light-emitting module 140a displays yellow, it corresponds to a second rotational speed of the transmission shaft 122a; when light-emitting module 140a displays orange, it corresponds to a third rotational speed of the transmission shaft 122a; and when light-emitting module 140a displays red, it corresponds to a fourth rotational speed of the transmission shaft 122a. Here, the first rotational speed is less than the second rotational speed, the second rotational speed is less than the third rotational speed, and the third rotational speed is less than the fourth rotational speed. The configuration of the light-emitting module 140a enables users to intuitively and quickly understand the rotational speed of the motor 121a, thereby allowing them to promptly adjust the pressure applied to the operation portion 112a, and thus control the output speed of the motor 121a.

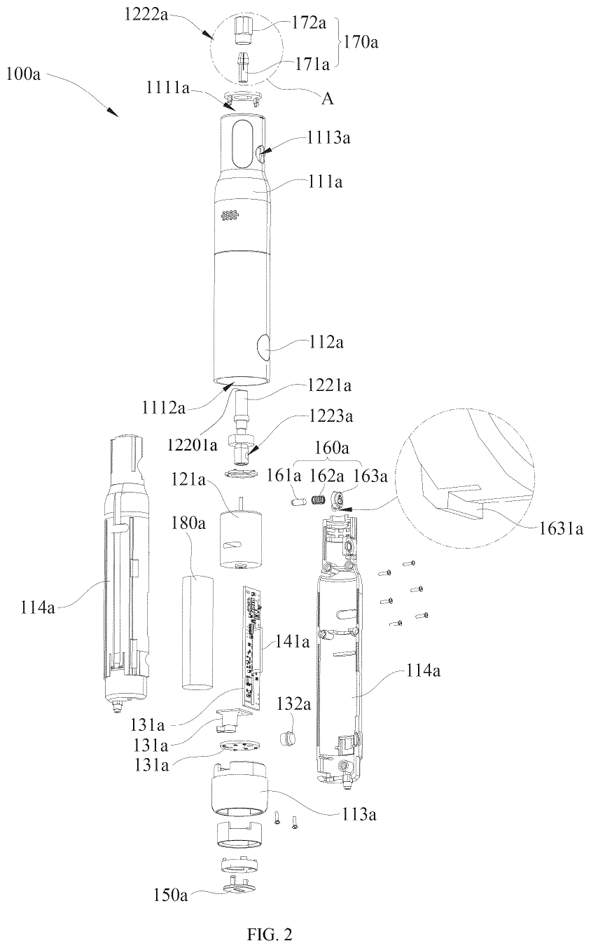

Referring to FIG. 2, the driving mechanism 120a further includes a battery 180a and a switch mechanism 113a that includes a movable member 113. The movable member 113 can move to a first position and a second position relative to the housing assembly 110a. When the movable member 113 moves to the first position, the battery 180a is electrically connected to the controller 131a, thereby activating the motor 121a. When the movable member 113 moves to the second position, the controller 131a is disconnected from the battery 180a, thereby deactivating the motor 121a. The rotational speed of the transmission shaft 122a gradually decreases during the movement of the movable member 113 from the first position to the second position. In one embodiment, the movement of the movable member 113 relative to the housing assembly 110a includes, but is not limited to, rotation. That is, the movable member 113 may be rotatably connected to the housing body 111a and may rotate between the first position and the second position relative to the housing body 111a. In another embodiment, the movable member 113 may be slidable relative to the housing assembly 110a to the first position and the second position, which will not be described in detail herein.

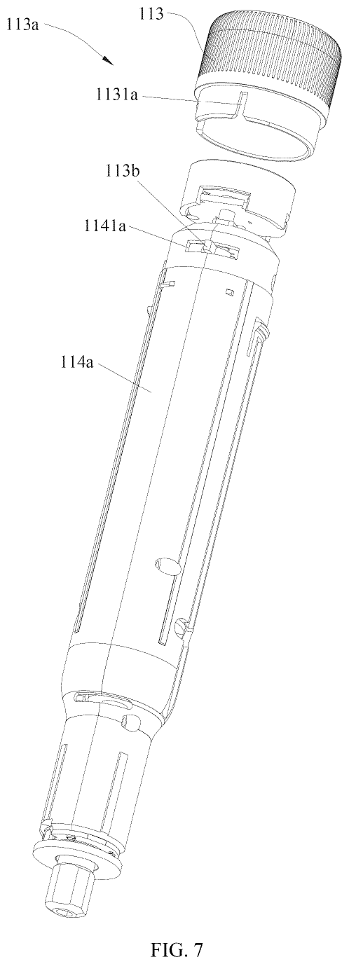

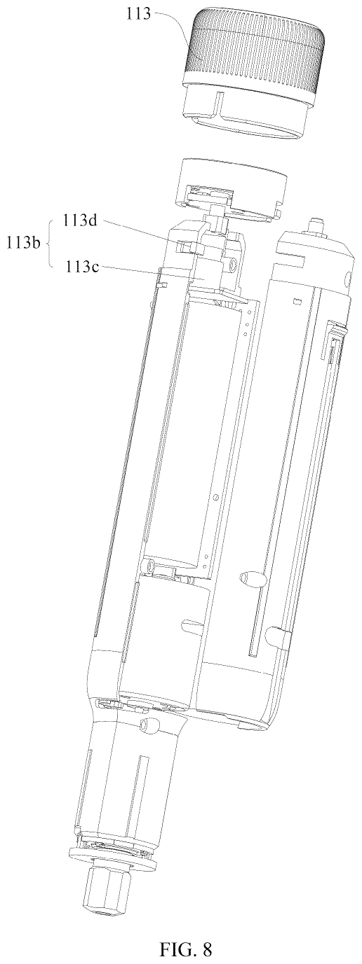

In one embodiment, the housing body 111a defines a first opening 1111a and a second opening 1112a. the first port 1111a and the second port 1112a are arranged opposite to each other along the axial direction of the transmission shaft 122a, and the second end 1222a passes through the first opening 1111a. The movable member 113 is arranged at the second opening 1112a, and can be arranged around the external surface of the end of the housing body 111a near the second opening 1112a. Alternatively, the movable member 113 can be arranged on the side of the second opening 1112a away from the first opening 1111a. The movable member 113 is configured to be rotatable to the first position and the second position relative to the housing body 111a around the axis of the second opening 1112a. Referring to FIGS. 7-9, in one embodiment, the movable member 113 is a hollow cylinder with an open end at one end, and the switch mechanism 113a further includes a sensing element 113b arranged in the housing assembly 110a. The sensing element 113b is a rotary potentiometer and includes a sensor body 113c and a handle 113d rotatably connected to the sensor body 113c. The movable member 113 is rotatably connected to the housing assembly 110a. In one embodiment, the sensing element 113b is disposed in the inner housing 114a, and the movable member 113 is arranged around the external surface of the inner housing 114a. The movable member 113 includes a handle matching portion, which is engaged with the handle 113d, thereby allowing the handle 113d to rotate under the push of the movable member 113, thereby changing the internal resistance of the sensing element 113b. The controller 131a controls the motor 121a to perform corresponding operations in response to the change in the internal resistance of the sensing element 113b. For example, the controller 131a adjusts the output speed of the motor 121a in response to a change in the internal resistance of the sensing element 113b.

In one embodiment, the external surfaces of the inner housing 114a is provided with a groove 1141a extending along its circumferential direction, and the end of the handle 113d of the sensing element 113b passes through the groove 1141a and is exposed. The movable member 113 is provided with a receiving groove 1131a extending from its open end in a direction parallel to the axis of rotation of the movable member 113, and the receiving groove 1131a is the handle matching portion. The exposed end of the handle 113d is received in the receiving groove 1131a. With such a configuration, when the movable member 113 is rotated by user operation, the exposed end of the handle 113d can be pushed by the side wall of the receiving groove 1131a, thereby causing the handle 113d to be pushed and rotate. As a result, the internal resistance of the sensing element 113b gradually increases or decreases as the movable member 113 rotates.

When the movable member 113 rotates to the first position, the controller 131a controls the motor 121a to be in an enabled state, that is, the motor 121a is in a state of being connected to the battery 180a. When the movable member 113 rotates to the second position, the controller 131a controls the motor 121a to be in an off state. Since a certain torque is required for the movable member 113 to switch from the first position to the second position or from the second position to the first position, external objects may come into contact with the driving module 100a during transportation and use, but it is difficult for such external objects to apply sufficient torque to the driving module 100a to cause the movable member 113 to switch between the first and second positions. Thus, the configuration of the movable member 113 further reduces the likelihood of accidental activation or deactivation of the driving module 100a's working state. In one embodiment, the sensing element 132a disposed at the inner side of the operation portion 112a can be used to control the output rotational speed of the motor 121a, and the movable member 113 can be used to control the activation or deactivation of the driving module 100a's working state.

In another embodiment, the sensing element 132a can be replaced by a switch 132b (e.g., a press-type switch). The switch 132b is arranged at the inner side of the operation portion 112a and facing the inner side of the operating portion 112a like the sensing element 132a. The operation portion 112a can trigger the switch 132b after being pressed by a user. The switch 132b is electrically connected to the controller 131a. After the switch 132b is triggered, the controller 131a controls the motor 121a to perform a corresponding operation. By providing the sensing element 113b and the switch 132b, the user is enabled to control the motor 121a to perform different operations. For example, in one embodiment, after the switch 132b is triggered, the controller 131a controls the activation or deactivation of the motor 121a. In this embodiment, the controller 131a adjusts the output speed of the motor 121a in response to the change of the internal resistance of the sensing element 113b caused by the rotation of the movable member 113. In another embodiment, after the switch 132b is triggered, the controller 131a controls the motor 121a to operate at a specific speed. For example, after the switch 132b is triggered for the first time, the controller 131a controls the motor shaft of the motor 121a to rotate at a first speed. After the switch 132b is triggered for the second time, the controller 131a controls the motor shaft of the motor 121a to rotate at a second speed. Following this sequential logic, the controller 131a can be configured to be able to recognize the sequence of switch 132b actuations, such that the controller 131a can control the motor shaft of the motor 121a to rotate at corresponding different speeds. In this embodiment, the controller 131a controls the activation and deactivation of the motor 121a in response to the change in the internal resistance of the sensing element 113b caused by the rotation of the movable member 113. For example, when the internal resistance of the sensing element 113b is the largest, the controller 131a controls the motor 121a to be deactivated, and when the internal resistance of the sensing element 113b is the smallest, the controller 131a controls the motor 121a to be activated.

In one embodiment, the driving module 100a includes a light emitting module 140a, and the movable member 113 can control the light emitting module 140a to turn on or off. In another embodiment, the movable member 113 can be used to control the activation and deactivation of the driving module 100a, and can also be used to control the light emitting module 140a to turn on or off.

In one embodiment, when the movable member 113 is in the first position, it can be configured to be rotatable relative to the housing body 111a about the axis of the second opening 1112a to multiple positions. When the movable member 113 rotates to each of the multiple positions, the controller 131a controls the motor 121a to be in an enabled state, and controls the transmission shaft 122a to have a corresponding speed range. The speed ranges corresponding to at least two first positions are different. Specifically, each first position may correspond to different operations such as engraving, grinding, drilling, polishing, and cutting. For example, during grinding operations, the transmission shaft 122a may operate within a speed range of 0-n₁ rpm, where n₁ ranges from 1,000 to 3,000. When the movable member 113 is rotated to the first position corresponding to grinding, the controller 131a, in response to pressure detected by the sensing element 132a, adjusts the rotational speed of the transmission shaft 122a within 0-n₁ rpm. During cutting operations, the transmission shaft 122a may operate within a speed range of 0-n₂ rpm, where n₂ ranges from 5,000 to 15,000. When the movable member 113 is rotated to the position corresponding to cutting, the controller 131a, in response to pressure detected by the sensing element 132a, adjusts the rotational speed of the transmission shaft 122a within 0-n₂ rpm. The speed range control of the transmission shaft 122a is achieved through pressure sensing by the sensing element 132a, which is arranged at the inner side of the operation portion 112a, enabling dynamic speed adjustment.

Referring to FIGS. 1-3, in one embodiment, the driving module 100a further includes a charging module 150a that is disposed in the housing assembly 110a. The charging module 150a has a charging port 151a, which is disposed in the housing body 111a. The charging port 151a is electrically connected to the battery 180a through the controller 131a. Specifically, the charging module 150a is disposed at the side of the second opening 1112a away from the first opening 1111a, and the movable member 113 is arranged around the charging module 150a. The charging port 151a is disposed away from the second opening 1112a. The charging port 151a can charge the battery 180a disposed in the housing body 111a. The inclusion of the charging port 151a and the battery 180a enables the driving module 100a to operate anywhere without relying on a fixed power outlet, significantly improving its convenience and flexibility. Additionally, this design helps reduce the frequency of cable usage and battery replacements, thereby lowering the maintenance costs of the driving module 100a. In one embodiment, the driving module 100a is provided with a power indicator light, which is arranged on the side of the second opening 1112a away from the first opening 1111a. The power indicator light is electrically connected to the controller 131a, and the controller 131a can monitor the voltage of the battery 180a of the driving module 100a, and feedback the power of the battery 180a by controlling the color of the power indicator light (or the number of illuminated indicator lights).

Referring to FIGS. 2 and 3, the driving module 100a further includes a limiting mechanism 160a, which has a first operational state and a second operational state. The transmission shaft 122a is rotatable when the limiting mechanism 160a is in the first operational state, and the transmission shaft 122a is nonrotatable when the limiting mechanism 160a is in the second operational state. The limiting mechanism 160a may adopt various structural configurations, which are not limited herein.

In one embodiment, when the limiting mechanism 160a is in the second operational state, the limiting mechanism 160a contacts the transmission shaft 122a and generates a frictional force opposing the rotational direction of the transmission shaft 122a. This counteractive friction is sufficient to neutralize the torque of the transmission shaft 122a, thereby maintaining the shaft in a stationary position relative to the housing assembly 110.

In one embodiment, the limiting mechanism 160a includes a stopper pin 161a, a spring 162a, and a button 163a. The stopper pin 161a is connected to the button 163a via the spring 162a. The button 163a is movably connected to the housing body 111a. A protrusion 1631a is formed on a lateral surface of the button 163a. The transmission shaft 122a is provided with a limit portion 1223a. When the limiting mechanism 160a is in the first operational state, the protrusion 1631a abuts against the housing body 111a, and the stopper pin 161a is disengaged from the limit portion 1223a. When the limiting mechanism 160a is in the second operational state, the limit portion 1631a is away from the housing body 111a, and the stopper pin 161a passes through a through hole 1113a and is engaged with the limit portion 1223a. The first opening 1111a and the second opening 1112a are arranged opposite to each other along the axial direction of the transmission shaft 122a, and the second end 1222a passes through the first opening 1111a. The through hole 1113a is defined at one end of the housing body 111a close to the first opening 1111a, and the limit portion 1223a faces the through hole 1113a.

In one embodiment, the limit portion 1223a provided on the transmission shaft 122a may be implemented as a groove, through-hole, snap-fit mechanism, or similar structure. Specifically, when the limit portion 1223a is configured as a through-hole and the limiting mechanism 160a is in the first operational state, the stopper pin 161a disengages from the limit portion 1223a of the transmission shaft 122a, thereby permitting the transmission shaft 122a to rotate freely with the motor 121a. When the limiting mechanism 160a is in the second operational state, the transmission shaft 122a passes through the through hole 1113a and the limit portion 1223a, thereby mechanically locking the transmission shaft 122a against rotation. In one embodiment, the limiting mechanism 160a can fix the transmission shaft 122a so that it can be stationary relative to the housing assembly 110a. When the button 163a is pressed, the stopper pin 161a is inserted into the limit portion 1223a of the transmission shaft 122a. When the pressure on the button 163a is removed, the stopper pin 161a can be separated from the limit portion 1223a of the transmission shaft 122a through the rebounding force of the spring 162a.

In one embodiment, the operation portion 112a has an inner side and an outer side opposite to each other, and the operation portion 112a is recessed from the outer side toward the inner side. That is, the external surface of the operation portion 112a is recessed inward, and the operation portion 112a is recessed inward toward the inside of the housing assembly 110a. The external surface of the operation portion 112a is lower than the external surface of the housing body 111a. When external objects contact the driving module 100a, they are naturally obstructed by the housing body 111a, preventing direct interaction with the operation portion 112a. The driving module 100a can effectively prevent foreign objects from acting on the sensing element 132a, further effectively reducing the likelihood of the sensing element 132a being accidentally touched.

It should be noted that the sensing element 132a can be a pressure sensor, which contacts the operation portion 112a to detect the pressure on the operation portion 112a. The sensing element 132a may be a temperature sensor, which contacts the operation portion 112a to measure the temperature of the operation portion 112a. In one embodiment, the sensing element 132a may include a pressure sensor and a temperature sensor. The pressure sensor is to obtain the pressure on the operation portion 112a, and the temperature sensor is to obtain the temperature of the operation portion 112a. When the pressure information obtained by the pressure sensor meets preset thresholds and the temperature information obtained by the temperature sensor meets preset thresholds, the communication between the controller 131a and the sensing element 132a is activated, and the controller 131a can adjust the rotational speed of the transmission shaft 122a according to the pressure information obtained by the pressure sensor. If the information obtained by either the pressure sensor or the temperature sensor does not meet preset thresholds, the communication between the controller 131a and the sensing element 132a is always closed. Therefore, the driving module 100a can achieve superior anti-misoperation performance.

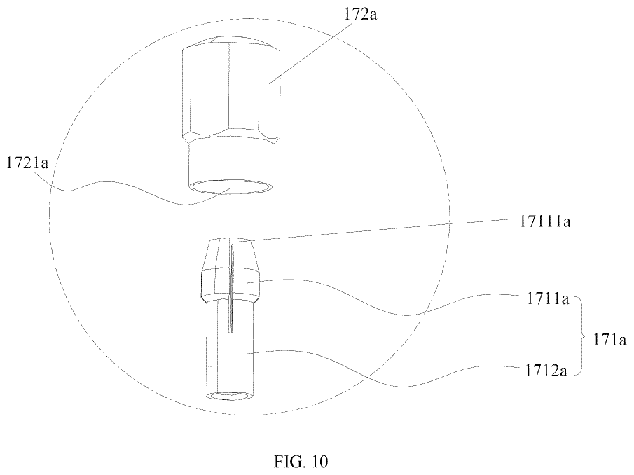

In one embodiment, the electric tool may further include a locking module 170a, through which the functional module 200a is detachably connected to the driving module 100a. The provision of the locking module 170a improves the connection reliability between the functional module 200a and the driving module 100a. In one embodiment, the locking module 170a may include a holder 171a and a locking cap 172a that is arranged around the holder 171a. The locking cap 172a is movable between a locking position and an unlocking position relative to the holder 171a. The locking cap 172a defines a locking hole 1721a (see FIG. 10). The transmission shaft 122a can be threadedly connected to the locking hole 1721a. The holder 171a includes a clamping member 1711a and a connection member 1712a. The transmission shaft 122a defines a shaft hole 12201a, and the connection member 1712a is connected to the shaft hole 12201a (see FIG. 2). For example, the connection member 1712a can be inserted into the shaft hole 12201a or threaded connected to the shaft hole 12201a. The clamping member 1711a defines a slit 17111a. When the locking cap 172a is in the locking position, the slit 17111a narrows, thereby enabling the clamping member 1711a to grip the functional module 200a. The functional module 200a can then rotate together with the transmission shaft 122a when the motor 121a drives the transmission shaft 122a to rotate. When the locking cap 172a is in the unlocking position, the slit 17111a widens, thereby allowing the clamping member 1711a to release the functional module 200a. In this case, the functional module 200a can be removed or replaced with a different one.

In one embodiment, the electric tool may further include an identification module 300a. The functional module 200a is electrically connected to the driving module 100a via the identification module 300a. The identification module 300a is to output a resistance of the functional module 200a to the controller 131a, and the controller 131a is to adjust an output rotational speed of the motor 121 based on the resistance. That is, the identification module 300a can identify the model of the functional module according to the resistance of the functional module mounted on the second end 1222a, and the controller 131a controls the speed range of the transmission shaft 122a according to the identified model. For example, if the functional module mounted on the second end 1222a is a grinding head, the identification module 300a detects the resistance of the functional module and transmits the resistance to the controller 131a, and the controller 131a controls the rotational speed of the transmission shaft 122a within the range of 0 to n₁ rpm based on the resistance. When the functional module mounted on the second end 1222a is a cutting tool, the identification module 300a detects the resistance of the functional module and transmits the resistance to the controller 131a, and the controller 131a controls the rotational speed of the transmission shaft 122a within the range of 0 to n₂ rpm based on the resistance.

Referring to FIGS. 2, 5 and 6, in one embodiment, the identification module 300a may include a conductive ring 320a and at least two conductive contacts 310a. The conductive ring 300a is disposed at an end of the functional module adjacent to the transmission shaft 122a. The at least two conductive contacts 310a are spaced apart from each other on the conductive ring 320a. The conductive ring 320a is electrically connected to the controller 131a via the at least two conductive contacts 310a. The conductive ring 310a is to detect a resistance signal of the functional module 200a, and the at least two conductive contacts 310a are to transmit the resistance signal to the controller 131a. Specifically, the conductive contacts 310a are arranged at intervals on the side of the second end 1222a away from the first end 1221a, and the two conductive contacts 310a are electrically connected to the controller 131a respectively. Each functional module is provided with a conductive ring 320a, which can be configured as a circular ring or a polygonal shape. After each functional module is connected to the second end 1222a, the two conductive contacts 310a respectively abut against two different positions of the conductive ring 320a. The conductive rings 320a connected to different types of functional modules are of different types, so that the resistance between the two conductive contacts 310a of the conductive rings 320a varies for different types of functional modules. The controller 131a can receive the signal of the resistance between the two conductive contacts 310a and identify the corresponding functional module according to the resistance. It should be noted that the differences in different conductive rings 320a include but are not limited to: different sizes of the conductive rings 320a of different functional modules, different materials of the conductive rings 320a of different functional modules, and different shapes of the conductive rings 320a of different functional modules.

In one embodiment, the sizes of the conductive rings 320a of different types of functional modules are different, so that the resistance of the parts of different conductive rings 320a located between the two conductive contacts 310a is different. For ease of description, the following description is given by taking the conductive ring 320a in a circular ring shape as an example. For example, if a first functional module is a drill bit, a first-type conductive ring 320a is provided on the drill bit, and the distance from the inner surface to the outer surface of the first-type conductive ring is a first distance. If the second functional module is an engraving bit, a second-type conductive ring 320a is provided on the engraving bit, and the distance from the inner surface to the outer surface of the second-type conductive ring 320a is a second distance. The maximum diameter of the first-type conductive ring 320a is equal to the maximum diameter of the second-type conductive ring 320a, and the first distance is not equal to the second distance. Therefore, after the first-type conductive ring 320a abuts against the two conductive contacts, there is a first resistance between the two conductive contacts, and after the second-type conductive ring 320a abuts against the two conductive contacts, there is a second resistance between the two conductive contacts, and the first resistance is not equal to the second resistance. The controller 131a can identify the model of the corresponding functional module by comparing the first resistance and second resistance with the preset resistance values of each functional module. In another embodiment, the resistivity of the conductive ring 320a of different functional modules is different, so that the resistance of the part of the conductive ring 320a of different models located between the two conductive contacts 310a is different. That is, the conductive rings 320a of different functional modules are made of materials with different resistivities, and the size of each conductive ring 320a can be the same.

Referring to FIG. 10, in one embodiment, a control method of the electric tool includes but is not limited to the following steps.

Step S101: The controller 131a obtains the pressure exerted on the operation portion 112a.

Step S102: If determining that the pressure exerted on the operation portion 112a is greater than a preset pressure value, the controller 131a adjusts the driving power of the motor 121a.

Step S103: The controller 131a adjusts one or more light-emitting parameters of the light-emitting module 140a such that the one or more light-emitting parameters correspond to the driving power of the motor 121a.

Step S104: The controller 131a obtains the model information of the functional module through the conductive ring 320a and the conductive contacts 310a.

Step S105: The controller 131a adjusts the rotational speed range of the transmission shaft 122a according to the model information of the functional module.

Specifically, taking the functional module as a grinding head as an example, the rotational speed range of the transmission shaft 122a is set to 0-2000 rpm, assuming that the output rotational speed of the motor 121a is equal to the rotational speed of the transmission shaft 122a. Accordingly, the 0-2000 rpm range can be divided into four speed levels: 0-500 rpm, 500-1000 rpm, 1000-1500 rpm and 1500-2000 rpm. Taking the sensing element 132a as a pressure sensor as an example for illustration: When the pressure exerted on the operation portion 112a exceeds a preset threshold, the speed range of the motor 121a can switch between the aforementioned four levels, and the lighting parameters of the light-emitting module 140a will adjust accordingly. In one embodiment, the lighting parameters of the light-emitting module 140a may change before the speed range adjustment of the transmission shaft 122a. In another embodiment, the lighting parameters may synchronize with the speed range adjustment of the transmission shaft 122a. For example, the speed range of the motor 121a can be adjusted from 0-500 rpm to 500-1000 rpm, or from 1500-2000 rpm to 0-500 rpm. Thus, the parameters of the light-emitting parameters of the light-emitting module 140a corresponding to the actual speed of the transmission shaft 122a are changed. Taking the light-emitting module 140a including the light strip 141a as an example, when the speed range of the motor 121a gradually increases, the illumination length of the light strip 141a gradually increases.

In one embodiment, the light-emitting module 140a includes a single light-emitting element, which is a light strip 141a, and the light strip 141a is configured to display different illumination lengths. In this embodiment, step S103 may include: when the driving power of the motor increases, the illumination length of the light strip 141a is controlled to increase accordingly; when the driving power of the motor decreases, the illumination length of the light strip 141a is controlled to decrease accordingly.

In another embodiment, the light-emitting module 140a includes a number of light-emitting lamps, each light-emitting lamp being arranged at intervals along a straight line. In this embodiment, step S103 may include: when the driving power of the motor increases, the number of illuminated lamps is controlled to increase; when the driving power of the motor decreases, the number of illuminated lamps is controlled to decrease.

In yet another embodiment, the light-emitting module 140a can display different colors. In this embodiment, step S103 may include: The light-emitting module 140a is controlled to display different colors.

In one embodiment, the control method of the electric tool may further include the following step after step S101: If the pressure exerted on the operation portion 112a is greater than a preset pressure value and the pressure is maintained for a time duration greater than a preset threshold, the driving power of the motor 121a is continuously adjusted, and the number of adjustments is a multiple of the maintenance time exceeding the preset time. In one embodiment, the controller 131a is provided with a speed regulating switch, and the sensing element 132a arranged at the inside of the operation portion 112a can receive the surface pressure of the operation portion 112a and transmit it to the trigger area of the speed regulating switch provided in the controller 131a, thereby realizing the cyclic control of the rotational speed of the transmission shaft 122a. For ease of description, the preset time is defined as 2 seconds. Therefore, when the pressure applied to the operation portion 112a has been maintained for 2 seconds, taking the functional module as a grinding head as an example, the rotational speed range of the transmission shaft 122a from 0-2000 rpm is divided into four levels of 0-500 rpm, 500-1000 rpm, 1000-1500 rpm and 1500-2000 rpm, and the number of times the driving power of the motor 121a is adjusted is one. That is, the rotational speed range of the transmission shaft 122a can be adjusted from 0-500 rpm to 500-1000 rpm, or from 1000-1500 rpm to 1500-2000 rpm. In another example, when the pressure applied to the operation portion 112a has been maintained for 4 seconds, the number of times the driving power of the motor 121a is adjusted is two. That is, the rotational speed range of the transmission shaft 122a can be adjusted from 0-500 rpm to 500-1000 rpm. In yet another example, when the pressure applied to the operation portion 112a has been maintained for 3 seconds, the number of times the driving power of the motor 121a is adjusted is one. That is, the rotational speed range of the transmission shaft 122a can be adjusted from 500-1000 rpm to 1000-1500 rpm, or from 1500-2000 rpm to 0-500 rpm.

In one embodiment, the control method of the electric tool may further include the following steps: determine the model of the functional module connected to the second end 1222a and adjust the rotational speed range of the transmission shaft 122a according to the model of the functional module.

Specifically, if the functional module connected to the second end 1222a is a grinding head, the controller 131a can adjust the rotational speed range of the transmission shaft 122a to 0-n1 rpm, such that the maximum rotational speed of the transmission shaft 122a when the electric tool is working can be n1 rpm. The actual rotational speed of the transmission shaft 122a can be adjusted by the controller 131a. Specifically, the controller 131a can adjust the rotational speed of the transmission shaft 122a within the range of 0-n1 rpm according to the pressure on the operation portion 112a and pressure maintenance time duration. If the functional module connected to the second end 1222a is a cutting tool, the controller 131a can adjust the rotational speed range of the transmission shaft 122a to 0-n2 rpm. Therefore, the maximum speed of the transmission shaft 122a when the electric tool is working can be n2 rpm. The actual rotational speed of the transmission shaft 122a can be adjusted by the controller 131a. Specifically, the controller 131a can adjust the rotational speed of the transmission shaft 122a within the range of 0-n2 rpm according to the pressure on the operation portion 112a and pressure maintenance time duration.

In one embodiment, the identification module 300a includes at least two conductive contacts 310a and a conductive ring 320a, and the model identification of a functional module can be realized by the identification module 300a. In this embodiment, the step of obtaining the model information of the functional module connected to the second end 1222a includes the following steps: obtain the resistance between the two conductive contacts 310a, obtain a resistance-to-model correspondence table for functional modules, and determine the model of the functional module connected to the second end 1222a based on the measured resistance and correspondence table.

In one embodiment, the step of adjusting the rotational speed range of the transmission shaft 122a according to the model information of the functional module includes the following steps: obtain a correspondence table mapping functional module models to speed ranges and determine a speed range based on the identified functional module model and the correspondence table; and obtain the number of speed levels of the driving module 100a, and determine the rotational speed value corresponding to each level based on the speed range, such that the speed values of each level are distributed in an arithmetic progression. Alternatively, the speed values can be distributed in an increasing manner, with the highest level corresponding to the maximum speed value of the speed range.

For example, if the electric tool is used for grinding, first, the electric tool is controlled to be in an “off” state (or the electric tool is in an “on” state, but the motor 121a is controlled to be in the stationary state), and the button 163a is pressed such that the stopper pin 161a is inserted into the limit portion 1223a of the transmission shaft 122a, thereby preventing the transmission shaft 122a from rotating. One end of the functional module (e.g., grinding head) provided with a conductive ring 320a is connected to the second end 1222a of the transmission shaft 122a, and the two conductive contacts 310a electrically connected to the controller 131a are electrically connected to the conductive ring 320a (in one embodiment, the two conductive contacts 310a abut against the conductive ring 320a to achieve electrical connection). Then, the pressure applied to the button 163a is removed, so that the stopper pin 161a is disengaged from the limit portion 1223a of the transmission shaft 122a. The electric tool is then turned on, and the controller 131a can then obtain the resistance value between the two conductive contacts 310a, and compare the resistance value with the resistance correspondence table of the conductive ring 320a of each functional module stored in the controller 131a, so as to obtain the model information of the functional module which represents the type of the functional module. The type of the functional module includes but is not limited to engraving bit, grinding head, polishing bit, cutting tool, and drill bit. The controller 131a adjusts the rotational speed range of the transmission shaft 122a according to the obtained model information of the functional module so that the speed range is suitable for the operation type of the functional module. The operation type of the functional module includes but is not limited to engraving, drilling, cutting, grinding, and polishing, and the speed range required for the operation type of each functional module is different. After determining the rotational speed range of the transmission shaft 122a, the controller 131a can divide the speed range into multiple speed levels, and the speed of each speed level can be distributed in an equidistant manner. Alternatively, the speed of each speed level can be distributed in an increasing manner, that is, speed differences between adjacent speed levels may vary. At the same time, the controller 131a adjusts the light-emitting parameters of the light-emitting module 140a (e.g., light strip 141a) so that the illumination length of the light strip 141a corresponds to the rotational speed of the transmission shaft 122a. After the operation portion 112a is pressed, the rotational speed of the transmission shaft 122a can be adjusted within the rotational speed range. The higher the rotational speed of the transmission shaft 122a, the longer the illumination length of the light strip 141a. When the rotational speed of the transmission shaft 122a reaches the maximum speed of its operational range, the light strip 141a can show the longest illumination length. It should be noted that the operation portion 112a supports multiple control modes. For example, the operation portion 1121 can be long pressed, meaning the longer the pressing duration, the higher the rotational speed of the transmission shaft 122a. Alternatively, the manner of pressing the operation portion 112a can be consecutive short presses, meaning the more frequent the short presses, the higher the rotational speed of the transmission shaft 122a.

When replacing the functional module of the electric tool, take, for example, the case where a second functional module is used to replace a first functional module connected to the transmission shaft 122a. First, the operation portion 112a is pressed to adjust the speed of the transmission shaft 122a to zero. The button 163a is then pressed to insert the stopper pin 161a into the limit portion 1223a of the transmission shaft 122a. The first functional module can then be removed, and one end of the second functional module provided with a conductive ring 320a is then connected to the second end 1222a of the transmission shaft 122a, and the two conductive contacts 310a electrically connected to the controller 131a are electrically connected to the conductive ring 320a. Then, the pressure applied to the button 163a is released, so that the stopper pin 161a is disengaged from the limit portion 1223a of the transmission shaft 122a. The controller 131a can obtain the resistance value between the two conductive contacts 310a, and compare the resistance value with the resistance correspondence table of the conductive ring 320a of each functional module stored in the controller 131a, so as to obtain the model information of the second functional module. The controller 131a adjusts the rotational speed range of the transmission shaft 122a according to the model information of the second functional module so that the speed range is suitable for the operation type of the second functional module. At the same time, the controller 131a adjusts the light-emitting parameters of the light-emitting module 140a (taking the light-emitting module including the light strip 141a as an example) so that the illumination length of the light strip 141a corresponds to the rotational speed of the transmission shaft 122a. The rotational speed of the transmission shaft 122a can be adjusted within the speed range by pressing the operation portion 112a. The higher the rotational speed of the transmission shaft 122a, the longer the illumination length of the light strip 141a. When the rotational speed of the transmission shaft 122a reaches the maximum speed of its operational range, the light strip 141a can show the longest illumination length.

In one embodiment, the housing assembly 110a further includes a movable member 113. The model identification of the functional module can be achieved by configuring the movable member 113 to be able to rotate to a number of first positions relative to the housing body 111a around the axis of the second opening 1112a. Thus, the step of adjusting the rotational speed range of the transmission shaft 122a according to the model information of the functional head includes the following step: drive the movable member 113 to rotate to the first position corresponding to the functional module model.

Specifically, the multiple first positions can represent cutting, drilling, engraving, grinding, and polishing modes, respectively, and a user can rotate the movable member 113 according to the type of operation actually required. For example, when the electric tool needs to be used for cutting operations, the electric tool is first controlled to be in an “off” state (or the electric tool is controlled to be in a “on” state, but the motor 121a is controlled to be in a stationary state), and the button 163a is pressed so that the stopper pin 161a is inserted into the limit portion 1223a of the transmission shaft 122a, thereby preventing the transmission shaft 122a from rotating. One end of the cutting tool is then connected to the second end 1222a of the transmission shaft 122a, and then the pressure applied to the button 163a is released, so that the stopper pin 161a is disengaged from the limit portion 1223a of the transmission shaft 122a. The electric tool is then turned on, and the movable member 113 is rotated to the first position corresponding to the cutting mode. Thus, the controller 131a can obtain the model information of the functional module according to the first position of the movable member 113, thereby adjusting the rotational speed range of the transmission shaft 122a to 0-n2 rpm. At the same time, the controller 131a divides the speed range into multiple levels, and the speed of each speed level can be distributed in an arithmetic distribution. Alternatively, the speed of each speed level can be distributed in an increasing manner, that is, speed differences between adjacent speed levels may vary. In addition, the controller 131a adjusts the light-emitting parameters of the light-emitting module 140a (taking the light-emitting module including the light strip 141a as an example) according to the speed range so that the illumination length of the light strip 141a corresponds to the rotational speed of the transmission shaft 122a. The rotational speed of the transmission shaft 122a can be adjusted within the speed range by pressing the operation portion 112a. The higher the rotational speed of the transmission shaft 122a, the longer the illumination length of the light strip 141a. When the rotational speed of the transmission shaft 122a reaches the maximum speed of its operational range, the light strip 141a can show the longest illumination length.

In one embodiment, the sensing element 132a arranged at the inside the operation portion 112a can also be used to control the activation and deactivation of the electric tool. Specifically, two preset time thresholds can be configured—referred to here as the first time and the second time for clarity, where the first time is longer than the second time. When the time duration of continuous pressing on the operation portion 112a is not less than the first time, the electric tool is turned on or off. When the electric tool is in the power-on state, if the time duration of continuous pressing on the operation portion 112a is not less than the second time and less than the first time, the speed level of the transmission shaft 122a is switched. If the time duration of continuous pressing on the operating portion 112a is not less than the first time, the electric tool is turned off.

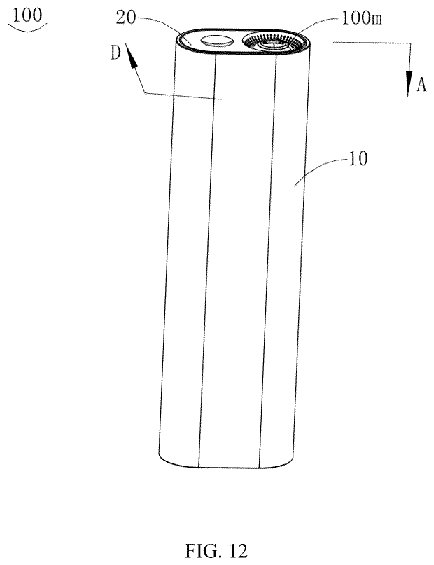

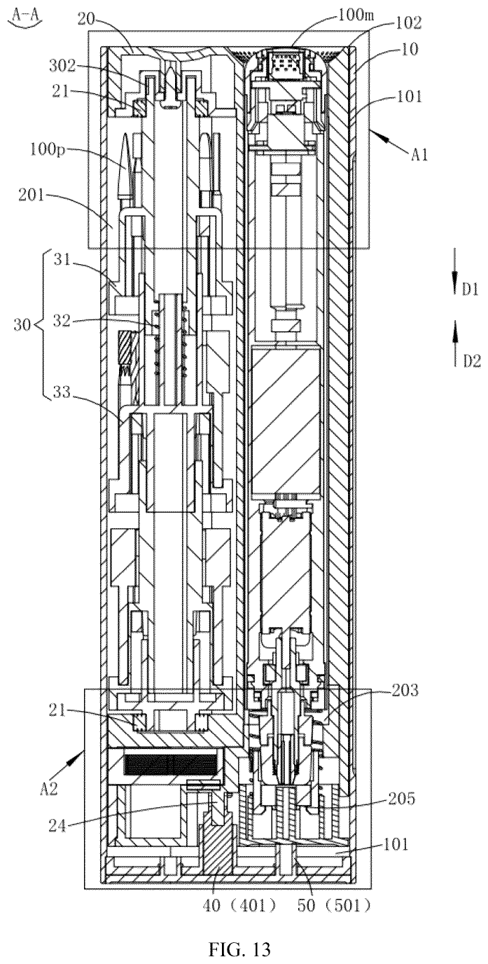

Referring to FIGS. 12 and 13, in one embodiment, a storage device 100 for accommodating an electric tool may include an outer case 10, an inner case 20, a holding member 30, a first connection mechanism 40, and a second connection mechanism 50. The inner case 20 is detachably received in the outer case 10. The inner case 20 is to receive one or more first to-be-received members 100p and a second to-be-received member 100m. Here, the second to-be-received member 100m is the main body of the electric tool, which is similar to the driving module 100a as described above. The one or more first to-be-received members 100p are accessories that can be detachably connected to the main body of the electric tool. They may include, but not limited to, screwdriver bits. The first connection mechanism 40 and the second connection mechanism 50 are both received in the outer case 10. The first connection mechanism 40 enables the detachable connection between the inner case 20 and the outer case 10. The second connection mechanism 50 allows for the detachable connection between either the inner case 20 or the outer case 10 and the second to-be-received members 100m. The holding member 30 is received in the inner case 20, and functions to hold the first to-be-received members 100p in position. The storage device 100 accommodates the first to-be-received members 100p, which may serve as accessories of an electric tool, thereby significantly enhancing user accessibility when locating/using the first to-be-received members 100p. The storage device 100 accommodates the second to-be-received member 100m, which can be the main body of the electric tool, thereby significantly enhancing user accessibility when operating the second to-be-received member 100m.

After the inner case 20 is unlocked from the outer case 10 and the second to-be-received member 100m is unlocked from the inner case 20 or the outer case 10, the second to-be-received member 100m and the first to-be-received members 100p are all handy and accessible to users, which can enhancing user accessibility when operating the second to-be-received member 100m and locating/using the first to-be-received members 100p. Additionally, the first connection mechanism 40 and second connection mechanism 50 can be operated simultaneously to unlock the inner case 20 from the outer case 10 and unlock the second to-be-received member 100m from the inner case 20 or the outer case 10. This significantly improves user convenience when handling the storage device, the first to-be-received members 100p, and the second to-be-received member 100m.

It should be noted that, in another embodiment, the storage device 100 may include the outer case 10, the inner case 20, the first connection mechanism 40 and the second connection mechanism 50, with the holding member 30 omitted. In this case, the first connection mechanism 40 is detachably connected to the inner case 20, and the second connection mechanism 50 allows for the detachable connection between either the inner case 20 or the outer case 10 and the second to-be-received members 100m. This configuration can enhance user accessibility when operating the storage device and the second to-be-received member 100m and locating/using the first to-be-received members 100p.

It should be noted that, in yet another embodiment, the storage device 100 may include the outer case 10, the inner case 20, and the holding member 30, with the first connection mechanism 40 and the second connection mechanism 50 omitted. In this embodiment, the inner case 20 is not required to have the function of accommodating the second to-be-received member 100m, and the holding member 30 can be taken out from the outer case 10 together with the inner case 20. This design allows the inner case 20 to protect the holding member 30 and the first to-be-received members 100p, which can protect users from being scratched by the sharp tips of the first to-be-received members 100p, thereby improving the user experience.

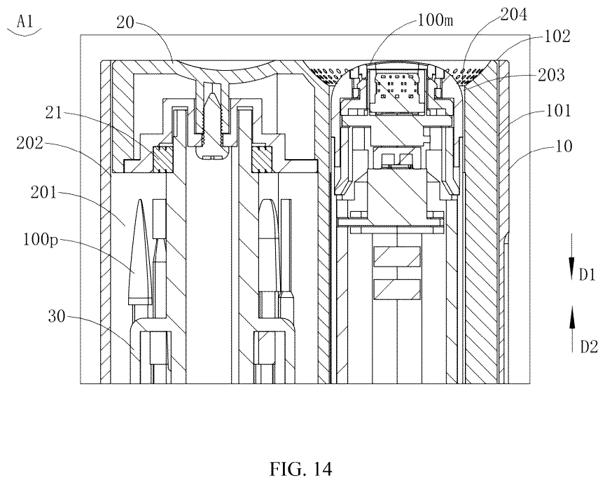

Referring to FIGS. 13 and 14, the outer case 10 is provided with a chamber 101 and an opening 102 in communication with the chamber 101. The chamber 101 is to receive the inner case 20, the first connection mechanism 40, the second connection mechanism 50, and the holding member 30, the first to-be-received members 100p and the second to-be-received member 100m in the inner case 20.

Referring to FIGS. 12, 15 and 16, the shape and configuration of the outer case 10 is adapted to the shape and configuration of the inner case 20, and meets the requirements of accommodating the inner case 20, the first connection mechanism 40, the second connection mechanism 50, and the holding member 30, the first to-be-received members 100p and the second to-be-received member 100m in the inner case 20. The shape of the outer case 10 can be, for example, a standard cylinder, or a variant cylinder with an elliptical or waist-shaped cross section, or a cube, etc.

Referring to FIGS. 13 and 14, the inner case 20 is insertable into the chamber 101 through the opening 102. The inner case 20 is detachably connected to the outer case 10 via the first connection mechanism 40. The inner case 20 is to accommodate the first to-be-received members 100p and/or the second to-be-received member 100m.

It should be noted that in order to facilitate description and help readers understand the design concept of the present disclosure, the direction from the opening 102 to the chamber 101 is defined as the first direction D1, and the second direction D2 is defined as the direction opposite to the first direction D1.

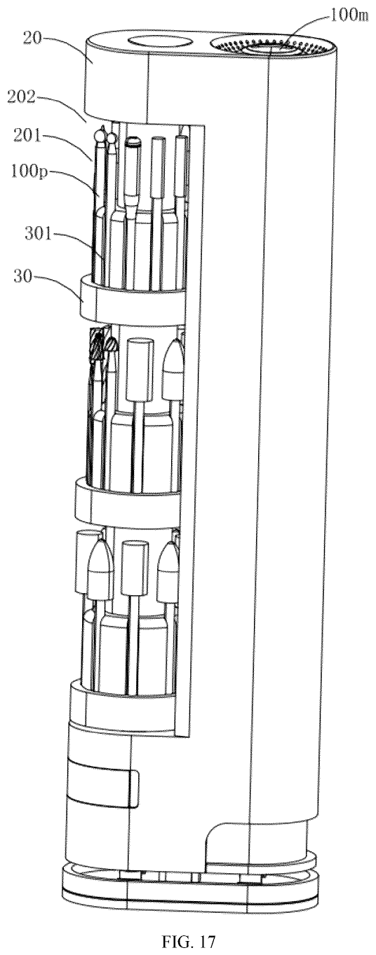

Referring to FIGS. 14 and 17, in one embodiment, the inner case 20 defines a first accommodation chamber 201 and a window 202 in communication with the first accommodation chamber 201. The first accommodation chamber 201 is to house the first holding member 30 that is to hold the first to-be-received members 100p in position. The window 202 is to expose at least a portion of the holding member 30, so that the first to-be-received members 100p secured on the holding member 30 is exposed, which facilitates users to take out the first to-be-received members 100p.

It should be noted that the exposure involved in the embodiment of the present disclosure means that the holding member 30 located at the window 202 can be seen from the outside of the inner case 20. When the first to-be-received members 100p is accommodated in the inner case 20, the exposure involved in the embodiment of the present disclosure also means that the first to-be-received members 100p located at the window 202 can be seen from the outside of the inner case 20. In addition, in terms of structure, exposure can mean that the holding member 30 partially protrudes from the first accommodation chamber 201 along the radial direction of the inner case 20, or it can mean that the holding member 30 is completely located in the first accommodation chamber 201.

It should be noted that, in one embodiment, the first accommodation chamber 201 may not be provided with the above-mentioned holding member 30, and the first accommodation chamber 201 may still realize the accommodating function of the first to-be-received members 100p. For example, the first to-be-received members 100p can be placed in the first accommodating chamber 201. When the holding member 30 is provided in the first accommodating chamber 201 and the first to-be-received members 100p are secured on the holding member 30, it is convenient to locate the first to-be-received members 100p.

It should be noted that the first accommodating chamber 201 can take various shapes, provided it accommodates the first to-be-received members 100p. For example, the first accommodating chamber 201 may be designed as: a standard cylinder, variant cylinder with an elliptical or waist-shaped cross section, or a cube.

Referring to FIG. 14, in one embodiment, the inner case 20 is provided with a second accommodation chamber 203 and a through hole 204 in communication with the second accommodation chamber 203. The second accommodation chamber 203 is to house the second to-be-received member 100m. The through hole 204 allows for the second to-be-received member 100m to be inserted into the second accommodation chamber 203, thereby realizing a detachable connection between the second to-be-received member 100m and either the inner case 20 or the outer case 10.

It should be noted that, in one embodiment, the through hole 204 is exposed at the opening 102. That is, when the inner case 20 is received in the outer case 10, the through hole 204 can be seen at the opening 102, so that the first direction D1 is also the direction from the through hole 204 to the second accommodation chamber 203.

It should be noted that the second accommodation chamber 203 can be designed in various configurations, provided it accommodates the second to-be-received member 100m. For example, the second accommodating chamber 203 may be designed as: a standard cylinder, variant cylinder with an elliptical or waist-shaped cross section, or a cube.

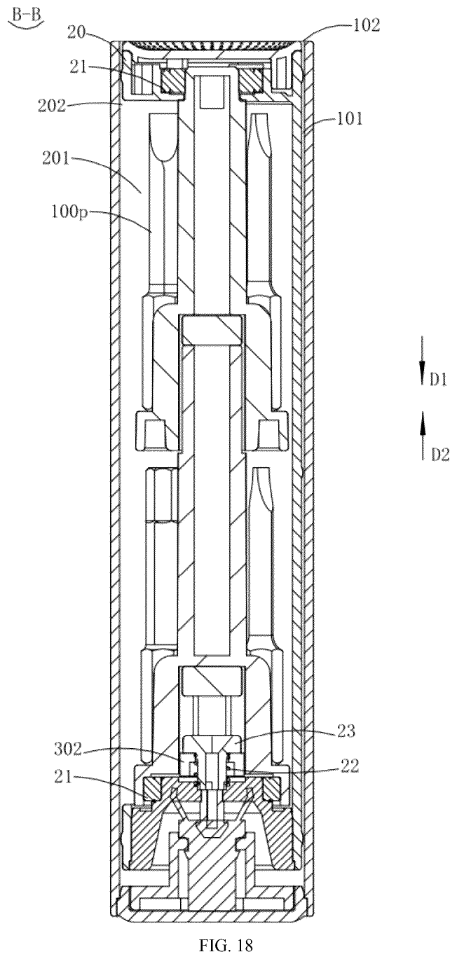

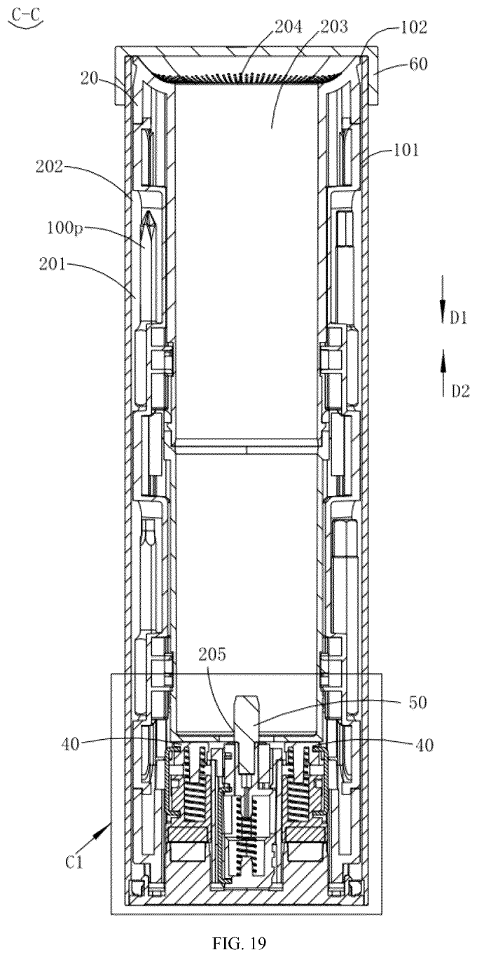

Referring to FIG. 18, in one embodiment, the inner case 20 is only provided with a first accommodation chamber 201 for accommodating the first to-be-received members 100p. Referring to FIG. 13, in one embodiment, the axis of the first accommodation chamber 201 and the axis of the second accommodation chamber 203 are arranged in parallel to each other. The axis of the first accommodation chamber 201 is the center line of the first accommodation chamber 201, and the axis of the second accommodation chamber 203 is the center line of the second accommodation chamber 203. Referring to FIG. 19, in one embodiment, the first accommodation chamber 201 and the second accommodation chamber 203 are arranged coaxially, which means that the center line of the first accommodation chamber 201 and the center line of the second accommodation chamber 203 coincide.

It should be noted that the inner case 20 is further provided with a number of components for use with the first connection mechanism 40 or the second connection mechanism 50. Specific details will be introduced in the following sections describing the first connection mechanism 40 and second connection mechanism 50.

Referring to FIG. 17, the holding member 30 is accommodated in the first accommodation chamber 201, and is movably connected to the inner case 20. The holding member 30 is provided with one or more mounting portions 301, and at least a portion of the one or more mounting portions 301 can be exposed through the window 202 of the inner case 20. The one or more mounting portions 301 are to secure the first to-be-received members 100p in position. The exposure means that at least a portion of the one or more mounting portions 301 can be seen from the window 202 from the outside of the inner case 20. The first to-be-received members 100p are secured by the one or more mounting portions 301 of the holding member 30, thereby improving the accessibility and ease of retrieval of the first to-be-received members 100p.

It should be noted that, in one embodiment, the mounting portions 301 are multiple in number and arranged circumferentially around the holding member 30.

The holding member 30 is movably connected to the inner case 20. In one embodiment, the holding member 30 is rotatably connected to the inner case 20, and the number of the mounting portions 301 is multiple, and the multiple mounting portions 301 are distributed along the rotational direction of the holding member 30. Each mounting portion 301 is to store one first to-be-received member 100p, so that multiple first to-be-received members 100p can be stored. In addition, when the holding member 30 is rotated, the multiple mounting portions 301 are alternately exposed to the window 202, which facilitates users to take the first to-be-received members 100p retained by the mounting portions 301.

It should be noted that, in one embodiment, as shown in FIG. 14, the inner case 20 is provided with at least one bearing 21 located in the first accommodation chamber 201. The holding member 30 is arranged on the bearing 21, so as to realize the rotational connection between the holding member 30 and the inner case 20.

The holding member 30 is movably connected to the inner case 20. In one embodiment, the holding member 30 is retractable along the first direction D1. Referring to FIG. 13, the holding member 30 includes a first bracket 31, a second elastic member 32, and a second bracket 33 connected in sequence along the first direction D1. The first bracket 31 abuts against the inner case 20, and the second bracket 33 abuts against the inner case 20. The first bracket 31 is provided with a number of the mounting portions 301, and the second bracket 33 is provided with a number of the mounting portions 301.

It should be noted that the second elastic member 32 can be a leaf spring, a coil spring, a gas spring, or a rubber spring.

It should be noted that the solution for achieving the retractable holding member 30 through the first bracket 31, the second elastic member 32, and the second bracket 33 can be varied in multiple ways. In one embodiment, along the first direction D1, the first bracket 31 and the second bracket 33 are arranged at a distance from each other, with the second elastic member 32 connected between them. The second elastic member 32 is compressed, and can cause the first bracket 31 to move relative to the inner case 20 along the first direction D1—that is, away from the opening 102, which can stretch the second elastic member 32 or allow it to return to its original length. The first bracket 31 can also be caused to move relative to the inner case 20 along the first direction D1. That is, the first bracket 31 can be moved toward the opening 102 along the second direction D2 opposite to the first direction D1. Similarly, by compressing the second elastic member 32, stretching the second elastic member 32 or restoring the second elastic member 32 to its original length state, the second bracket 33 can move relative to the inner case 20 along the first direction D1. The specific implementation principle of the second bracket 33 moving relative to the inner case 20 along the first direction D1 can refer to the above description of the movement of the first bracket 31 relative to the inner case 20 along the first direction D1, which will not be repeated here.

In one embodiment, the second bracket 33 is partly inserted into the first bracket 31, one end of the second elastic member 32 is connected to an end of the first bracket 31 close to the second bracket 33, and the other end of the second elastic member 32 is connected to an end of the second bracket 33 close to the first bracket 31, so that the first bracket 31 can move relative to the inner case 20 along the first direction D1 or the second bracket 33 can move relative to the inner case 20 along the first direction D1 through the second elastic member 32. The specific implementation principle of the movement of the first bracket 31 and the second bracket 33 relative to the inner case 20 along the first direction D1 can refer to the relevant description of the above-mentioned first bracket 31 and the second bracket 33 when they are arranged apart from each other, which will not be repeated here.

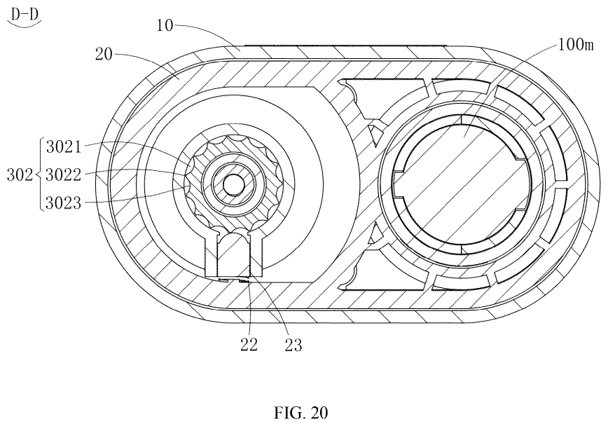

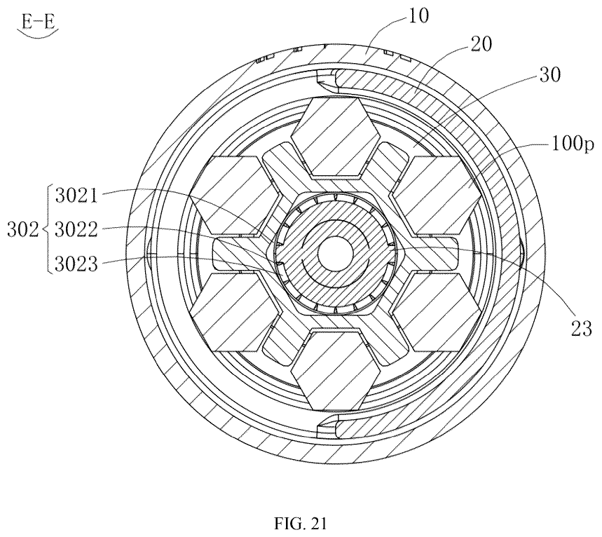

It should be noted that, in one embodiment, to enhance user enjoyment when operating the storage device 100, the storage device 100 may produce sound when the holding member 30 is rotated. As shown in FIGS. 20 and 21, the holding member 30 is provided with a first engaging member 302, while the inner case 20 includes a first elastic member 22 and a second engaging member 23. The first elastic member 22 is connected to the inner case 20, and the second engaging member 23 is attached to the end of the first elastic member 22 away from the inner case 20. The second engaging member 23 is designed to engage with the first engaging member 302. When the holding member 30 rotates relative to the inner case 20, the first engaging member 302 periodically pushes the second engaging member 23 to move toward the first elastic member 22, causing the first elastic member 22 to alternately compress, stretch, or return to its original length. As a result, the first elastic member 22 drives the second engaging member 23 to move away from the first engaging member 302 (when compressed) and toward the first engaging member 302 (when released). This cyclic interaction causes repeated collisions between the first engaging member 302 and the second engaging member 23, generating audible clicks or sounds for user feedback.

It should be noted that, in one embodiment, both the first engaging member 302 and the second engaging member 23 are made of metal, which facilitates sound generation when they collide. Of course, alternative materials such as plastic are also possible—either both components being plastic or one being metal and the other plastic.

It should be noted that the first elastic member 22 may be implemented as a leaf spring, coil spring, gas spring, rubber spring, or similar elastic mechanism.

It should be noted that, in one embodiment, the first engaging member 302 may include a main body 3021, multiple protrusions 3022, and multiple recesses 3023. Each recess 3023 is formed between two adjacent protrusions 3022. These protrusions and recesses are arranged along the rotational direction of the holding member on the main body 3021. When the second engaging member 23 contacts a protrusion 3022, the first elastic member 22 drives the second engaging member 23 away from the first engaging member 302. When the second engaging member 23 aligns with a recess 3023, it moves toward the first engaging member 302 under elastic force. This cyclic interaction causes the second engaging member 23 to alternately collide with the protrusions 3022 and recesses 3023, generating audible feedback (e.g., clicks) during rotation.

Referring to FIGS. 18, 22 and 23, the first connection mechanism 40 is disposed in the chamber 101, and the inner case 20 is detachably connected to the first connection mechanism 40. The second connection mechanism 50 is disposed in the chamber 101, and the second switch 50 functions to detachably connect either the inner case 20 or the outer case 10 to the second to-be-received member 100m.

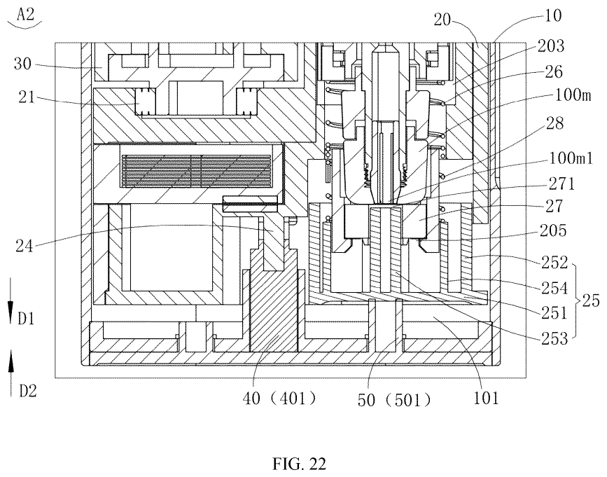

In one embodiment, Referring to FIGS. 18 and 22, the first connection mechanism 40 is a push latch 40 that is disposed at the bottom of the chamber 101. Specifically, the inner case 20 can enter the chamber 101 of the outer case 10 from the opening 102 of the outer case 10 until it reaches the bottom of the chamber 101, and is locked by the first connection mechanism 40. The inner case 20 is provided with a connecting portion 24, and the connecting portion 24 is detachably connected to the push latch 401. That is, the inner case 20 and the first connection mechanism 40 are locked and unlocked by the connecting portion 24 of the inner case 20. Specifically, by pressing the inner case 20, the inner case 20 can be locked to the first connection mechanism 40, and by pressing the inner case 20 again, the inner case 20 can be unlocked from the first connection mechanism 40. It should be noted that the push latch is a well-known mechanical fastening or locking device that opens or releases when pushed, which will not be described in detail here.

It should be noted that the first connection mechanism 40 and the second connection mechanism 50 may adopt the same structure. That is, the second connection mechanism 50 may be a push latch 401. It is understandable that the first connection mechanism 40 and the second connection mechanism 50 may adopt different structural designs.

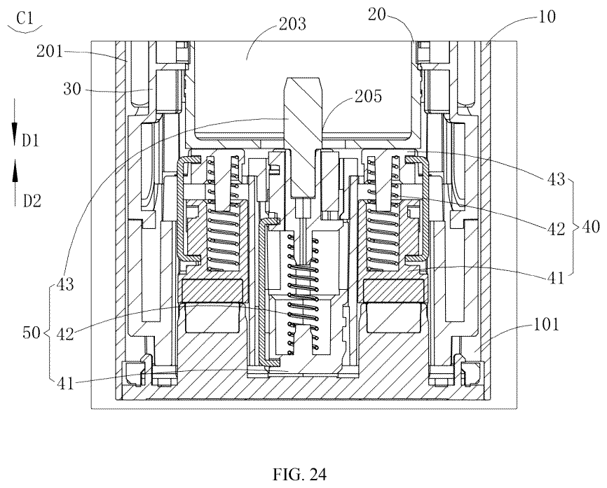

It should be noted that the locking and unlocking functionality of the first connection mechanism 40 for the inner case 20 is not limited to the aforementioned design and may adopt alternative mechanisms. Referring to FIG. 23, in one embodiment, the first connection mechanism 40 or the second connection mechanism 50 includes a mounting member 41, an elastic connecting member 42 and a magnetic member 43 connected in sequence. The mounting member 41 is arranged at the bottom of the chamber 101, and the magnetic member 43 can be magnetically connected to the inner case 20 or the second to-be-received member 100m. When the inner case 20 is received in the outer case 10, by pressing the inner case 20, the elastic connecting member 42 stretches or restores its original length, thereby driving the inner case 20 to be disengaged from the outer case 10. In another scenario, as the inner case 20 enters the chamber 101 from the opening 102, the elastic connecting member 42 is reset or compressed, so that the inner case 20 contacts with the magnetic member 43, and the inner case 20 or the second to-be-received member 100m is magnetically connected with the magnetic member 43. As a result, the inner case 20 or the second to-be-received member 100m is detachably connected with the outer case 10.

It should be noted that the elastic connecting member 42 can be a leaf spring, a coil spring, a gas spring, or a rubber spring.

It should be noted that, since the second to-be-received member 100m is arranged in the second accommodation chamber 203, and the magnetic member 43 is located in the chamber 101, when the second to-be-received member 100m is magnetically connected with the magnetic member 43, the inner case 20 is provided with an mounting hole 205 that is in communication with the second accommodation chamber 203 and the chamber 101. The mounting hole 205 is used for the second to-be-received member 100m to be detachably connected with the outer case 10.

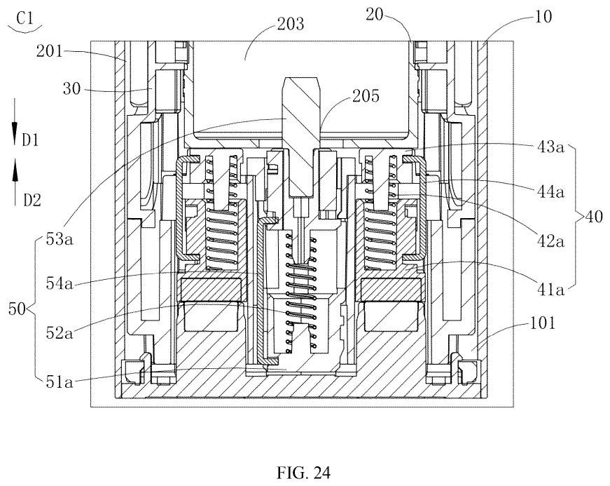

The implementation of the first connection mechanism 40 can take various forms. For example, in one embodiment, as shown in FIG. 24, the first connection mechanism 40 includes a first mounting member 41a, a first elastic connecting member 42a, a first magnetic member 43a and a first fastener 44a. The first mounting member 41a, the first elastic connecting member 42a and the first magnetic member 43a are connected in sequence. The first mounting member 41a is arranged at the bottom of the chamber 101. The first magnetic member 43a can be magnetically connected to the inner case 20. One end of the first fastener 44a is arranged on the first magnetic member 43a, and the other end of the first fastener 44a is engaged with the first mounting member 41a. When the first magnetic member 43a moves relative to the first mounting member 41a through the first elastic connecting member 42a, the first fastener 44a moves in the same direction as the first magnetic member 43a relative to the first mounting member 41a. When the inner case 20 is accommodated in the outer case 10, by pressing the inner case 20, the first elastic connecting member 42a stretches or returns to its original length, thereby driving the inner case 20 to be disengaged from the outer case 10. In another scenario, after the inner case 20 enters the chamber 101 from the opening 102, and by pressing the inner case 20, the first elastic connecting member 42a is reset or compressed, so that the inner case 20 contacts with the first magnetic member 43a, realizing the magnetic connection between the inner case 20 and the first magnetic member 43a, that is, realizing the detachable connection between the inner case 20 and the outer case 10 through the first connection mechanism 40.

In addition, through the first fastener 44a, when the inner case 20 is accommodated in the outer case 10, by pressing the inner case 20, the first fastener 44a limits the distance over which the first elastic connecting member 42a drives the first magnetic member 43a to move relative to the first mounting member 41a, so that when the inner case 20 enters the chamber 101 from the opening 102, it is convenient for the first elastic connecting member 42a to be reset or compressed, so as to realize the magnetic connection between the inner case 20 and the first magnetic member 43a.

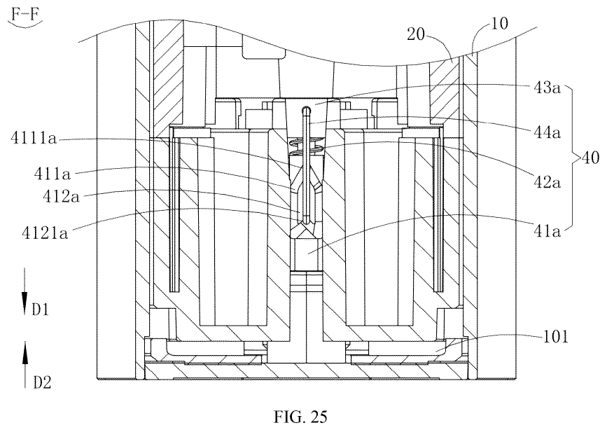

It should be noted that one end of the first fastener 44a is disposed on the first magnetic member 43a. In one embodiment, the end of the first fastener 44a can be fixed to the first magnetic member 43a. In another embodiment, the end of the first fastener 44a can be integrally formed with the first magnetic member 43a. In yet another embodiment, the end of the first fastener 44a can be inserted into the first magnetic member 43a. The other end of the first fastener 44a is engaged with the first mounting member 41a. When the first magnetic member 43a moves relative to the first mounting member 41a through the first elastic connecting member 42a, the first fastener 44a moves in the same direction as the first magnetic member 43a relative to the first mounting member 41a. The other end of the first fastener 44a can be engaged with the first mounting member 41a or connected to the first mounting member 41a in a manner as shown in FIG. 25. Specifically, as shown in FIG. 25, the first mounting member 41a is provided with a first sliding groove 411a and a first limiting member 412a. The first sliding groove 411a is arranged around the first limiting member 412a. The first sliding groove 411a has a first position 4111a close to the first magnetic member 43a. The first limiting member 412a is provided with a first limiting portion 4121a. The first limiting portion 4121a is arranged away from the first magnetic member 43a. When the inner case 20 is received in the outer case 10, the other end of the first fastener 44a is engaged with the first limiting portion 4121a. When the inner case 20 is pressed, the first elastic connecting member 42a is first compressed. The other end of the first fastener 44a is away from the first limiting portion 4121a, and the other end of the first fastener 44a is free from the restriction of the first limiting portion 4121a. The first elastic connecting member 42a stretches or returns to its original length, so that the other end of the first fastener 44a slides along the first sliding groove 411a to the first position 4111a, thereby driving the inner case 20 to be disengaged from the outer case 10. In another scenario, when the inner case 20 enters the chamber 101 from the opening 102, by pressing the inner case 20, the first elastic connecting member 42a is reset or compressed, and the other end of the first fastener 44a slides along the first sliding groove 411a to the first limiting portion 4121a, so that the inner case 20 is magnetically connected with the first magnetic member 43a.

It should be noted that the first elastic connecting member 42a can be a leaf spring, a coil spring, a gas spring, or a rubber spring.

It should be noted that, in one embodiment, the first connection mechanism 40 may not be provided with the first fastener 44 a, and the first switch 40 can still realize a detachable connection between the inner case 20 and the outer case 10.

The second connection mechanism 50 can adopt the same structure as the first connection mechanism 40. Specifically, as shown in FIG. 24, the second connection mechanism 50 includes a second mounting member 51a, a second elastic connecting member 52a, a second magnetic member 53a and a second fastener 54a. The second mounting member 51a, the second elastic connecting member 52a and the second magnetic member 53a are connected in sequence. The second mounting member 51a is arranged at the bottom of the chamber 101. One end of the second magnetic member 53a away from the bottom of the chamber 101 extends from the mounting hole 205 of the inner case 20 to the second accommodation chamber 203. The second magnetic member 53a can be magnetically connected with the second to-be-received member 100m. One end of the second fastener 54a is arranged on the second magnetic member 53a, and the other end of the second fastener 54a is connected with the second mounting member 51a. When the second magnetic member 53a moves relative to the second mounting member 51a through the second elastic connecting member 52a, the second fastener 54a moves in the same direction relative to the second mounting member 51a as the second magnetic member 53a. When the inner case 20 is accommodated in the outer case 10, by pressing the inner case 20 or the second to-be-received member 100m, the second elastic connecting member 52a is stretched or restored to its original length, thereby driving the second to-be-received member 100m to be disengaged from the inner case 20 or the outer case 10. In another scenario, after the second to-be-received member 100m enters the second accommodation chamber 203, by pressing the inner case 20 or the second to-be-received member 100m, the second elastic connecting member 52a is reset or compressed, so that the second to-be-received member 100m contacts the second magnetic member 53a, thereby realizing the magnetic connection between the second to-be-received member 100m and the second magnetic member 53a. That is, the detachable connection between the second to-be-received member 100m and either the inner case 20 or the outer case 10 is realized through the second connection mechanism 50.

In addition, through the second fastener 54a, when the inner case 20 is accommodated in the outer case 10, by pressing the inner case 20, the second fastener 54a limits the distance over which the second elastic connecting member 52a drives the second magnetic member 53a to move relative to the second mounting member 51a, so that when the second to-be-received member 100m enters the second accommodation chamber 203, it is convenient for the second elastic connecting member 52a to be reset or compressed, so as to realize the detachable connection between the second to-be-received member 100m and the inner case 20 or the outer case 10.

It should be noted that one end of the second fastener 54a is disposed on the second magnetic member 53a. In one embodiment, the end of the second fastener 54a can be fixed to the second magnetic member 53a. In another embodiment, the end of the second fastener 54a can be integrally formed with the second magnetic member 53a. In yet another embodiment, the end of the second fastener 54a can be inserted into the second magnetic member 53a. The other end of the second fastener 54a is engaged with the second mounting member 51a. When the second magnetic member 53a moves relative to the second mounting member 51a through the second elastic connecting member 52a, the second fastener 54a moves in the same direction as the second magnetic member 53a relative to the second mounting member 51a. The other end of the second fastener 54a can be engaged with the second mounting member 51a or connected to the second mounting member in other manners. For example, the second mounting member 51a is provided with a second sliding groove (not shown) and a second limiting member (not shown). The second sliding groove is arranged around the second limiting member. The second sliding groove has a second position close to the second magnetic member 53a. The second limiting member is provided with a second limiting portion, and the second limiting portion is arranged away from the second magnetic member 53a. When the second to-be-received member 100m is accommodated in the second accommodation chamber 203 of the inner case 20, the other end of the second fastener 54a is engaged with the second limiting portion. When the inner case 20 or the second to-be-received member 100m is pressed, the second elastic connecting member 52a is first compressed. The other end of the second fastener 54a is away from the second limiting portion, and the other end of the second fastener 54a is free from the restriction of the second limiting portion. The second elastic connecting member 52a stretches or returns to its original length, so that the other end of the second fastener 54a slides along the second sliding groove to the second position, so that the second to-be-received member 100m is disengaged from the inner case 20 or the outer case 10. In another scenario, when the second to-be-received member 100m enters the second accommodation chamber 203, the second elastic connecting member 52a can be reset or compressed by pressing the inner case 20 or the second to-be-received member 100m, and the other end of the second fastener 54a slides along the second sliding groove to the second limiting portion, thereby realizing the magnetic connection between the second to-be-received member 100m and the second magnetic member 53a.

It should be noted that the second elastic connecting member 52a can be a leaf spring, a coil spring, a gas spring, or a rubber spring.

It should be noted that, in one embodiment, the second connection mechanism 50 may not be provided with the second fastener 54a, and the second connection mechanism 50 can still realize a detachable connection between the second to-be-received member 100m and the inner case 20 or the outer case 10.

It should be noted that the second connection mechanism 50 is not limited to the aforementioned configuration and may adopt other implementations. Specifically, as shown in FIG. 22, the second connection mechanism 50 may include an unlocking member 501, which is disposed at the bottom of the chamber 101. The inner case 20 is provided with a movable member 25 at its end facing the second connection mechanism 50, and the unlocking member 501 can act on the movable member 25. The movable member 25 is detachably connected to the second to-be-received member 100m. Through the unlocking member 501 and the movable member 25 provided in the inner case 20, the second connection mechanism 50 can unlock and lock the second to-be-received member 100m, the inner case 20 or the outer case 10.

It should be noted that, in one embodiment, the inner case 20 is provided with a first elastic member 26 and a magnetic member 27. Under the abutment of the unlocking member 501, the movable element 25 can move relative to the inner case 20 along the first direction D1 or the second direction D2 through the mounting hole 205. The first elastic member 26 extends along the first direction D1. The initial state of the first elastic member 26 is not specifically limited. One end of the first elastic member 26 is connected to the inner case 20, and the other end of the first elastic member 26 is connected to the movable element 25. Alternatively, one end of the first elastic member 26 is connected to the inner case 20, and the other end of the first elastic member 26 is connected with the second to-be-received member 100m. The magnetic member 27 is provided in the second accommodation chamber 203, and the magnetic member 27 is to magnetically connect with the second to-be-received member 100m by magnetic attraction. It can be understood that when the first elastic member 26 is connected to the inner case 20 and the movable member 25, the inner case 20 defines a groove in its inner surface. A portion of the first elastic member 26 along the radial direction abuts against the groove, and another portion of the first elastic member protrudes from the groove, so that the second to-be-received member 100m extending from the opening 102 can abut against the first elastic member 26. When the first elastic member 26 is connected to the inner case 20 and the second to-be-received member 100m, one end of the first elastic member 26 is connected to the bottom of the inner case 20 along the first direction D1, and the other end is in a free state and can abut against the first elastic member 26 when the second to-be-received member 100m extends from the opening 102.

When the inner case 20 is arranged in the outer case 10 and the inner case 20 is pressed along the first direction D1 at the opening 102, the first connection mechanism 40 is switched to an unlock state. The unlocking member 501 acts on the movable member 25, so that the movable member 25 protrudes from the magnetic member 27 along the second direction D2. The first elastic member 26 stretches or returns to its original length. The first elastic element 26 can drive the second to-be-received member 100m arranged in the second accommodation chamber 203 to move away from the magnetic member 27, and drive the inner case 20 to move away from the bottom of the chamber 101, so as to realize the unlocking of the inner case 20 from the outer case 10, and realize the unlocking of the second to-be-received member 100m from the inner case 20 or the outer case 10. In another scenario, when the inner case 20 is inserted into the chamber 101 through the opening 102 and the inner case 20 is pressed along the first direction D1 at the opening 102, the first connection mechanism 40 is locked. When second to-be-received member 100m is pressed along the first direction D1, the first elastic member 26 is compressed, and the second to-be-received member 100m received in the second accommodation chamber 203 moves toward the magnetic member 27, so that the second to-be-received member 100m is magnetically connected with the magnetic member 27, thereby realizing the separate installation of the inner case 20 and the second to-be-received member 100m. That is, the locking of the inner case 20 to the outer case 10 by the first connection mechanism 40 is realized, and the locking of the second to-be-received member 100m to the inner case 20 is realized.

It should be noted that the first elastic member 52a can be a leaf spring, a coil spring, a gas spring, or a rubber spring.

It should be noted that, in one embodiment, the inner case 20 is further provided with a second elastic member 28 located in the second accommodation chamber 203, and the second elastic member 28 extends along the first direction D1. The initial state of the second elastic member 28 is not specifically limited. One end of the second elastic member 28 is connected to the inner case 20, and the other end of the second elastic member 28 is connected with the movable member 25. Through the second elastic member 28, after the second connection mechanism 50 unlocks the second to-be-received member 100m from the inner case 20 or the outer case 10, the movable member 25 can be reset toward the unlocking member 501, so that the unlocking member 501 acts on the movable member 25 next time, so as to realize that the second connection mechanism 50 unlocks the second to-be-received member 100m from the inner case 20 or the outer case 10. Specifically, when the inner case 20 is arranged in the outer case 10, and the inner case 20 is pressed along the first direction D1 at the opening 102, the first connection mechanism 40 is unlocked. The unlocking member 501 acts on the movable member 25 to make the movable member 25 protrude from the magnetic member 27 along the second direction D2. The first elastic member 26 stretches or returns to its original length, and the second elastic member 28 stretches or returns to its original length. The first elastic member 26 drives the second to-be-received member 100m arranged in the second accommodation chamber 203 to move away from the magnetic member 27, and the inner case 20 moves away from the bottom of the chamber 101, thereby realizing the unlocking of the inner case 20 from the outer case 10, and at the same time realizing the unlocking of the second to-be-received member 100m from the inner case 20 or the outer case 10.

It should be noted that the second elastic member 28 can be a leaf spring, a coil spring, a gas spring, or a rubber spring.

It should be noted that when the second connection mechanism 50 unlocks or locks the second to-be-received member 100m, the movable member 25 plays an important role. One implementation of the movable member 25 is that the movable member 25 includes a contact member 251, a sliding member 252, a pushing member 253 and an assembly member 254. The sliding member 252, the pushing member 253 and the assembly member 254 are arranged on the contact member 251, and the contact member 251 functions to contact the unlocking member 501. The sliding member 252 is arranged on the side of the contact member 251 facing away from the unlocking member 501, and one end of the sliding member 252 away from the contact member 251 is received in the inner case 20. The sliding member 252 can move relative to the inner case 20 along the first direction D1. The pushing member 253 and the assembly member 254 are both arranged on the side of the contact member 251 facing away from the unlocking member 501. The magnetic member 27 is provided with a sliding hole 271, and the end of the pushing member 253 away from the contact member 251 is inserted into the sliding hole 271. The pushing member 253 can move relative to the magnetic member 27 along the first direction D1, and the assembly member 254 is to connect with the other end of the second elastic element 28. Through the above configuration, the function of the movable member 25 can be realized.

It should be noted that, in one embodiment, the second to-be-received member 100m is provided with a receiving hole 100m1 for receiving one of the first to-be-received members 100p. When the second to-be-received member 100m is arranged in the second accommodation chamber 203, the center line of the receiving hole 100m1 coincides with the center line of the sliding hole 271. The diameter of the sliding hole 271 is larger than the diameter of the receiving hole 100m1, so that the pushing member 253 of the movable member 25 can avoid the receiving hole 100m1. When the movable member 25 protrudes from the magnetic member 27 along the second direction D2, the pushing member 253 can act on the second to-be-received member 100m, so that the second to-be-received member 100m arranged in the second accommodation chamber 203 moves away from the magnetic member 27, and the inner case 20 moves away from the bottom of the chamber.

It should be noted that the first connection mechanism 40 and the second connection mechanism 50 may adopt the same structure. That is, the first connection mechanism 40 may include an unlocking member 501. It is understandable that the first connection mechanism 40 and the second connection mechanism 50 may adopt different structural designs.

It should be noted that, through the above-mentioned first connection mechanism 40 and second connection mechanism 50, when the inner case 20 is accommodated in the outer case 10, only a single pressing action on the inner case 20 is required to simultaneously unlock the first connection mechanism 40 and unlock the second connection mechanism 50, thereby unlocking the inner case 20 from the outer case 10, and unlocking the second to-be-received member 100m from either the inner case 20 or the outer case 10.

It should be noted that the storage device 100 can be implemented in various configurations. Below are three specific embodiments of the storage device 100.

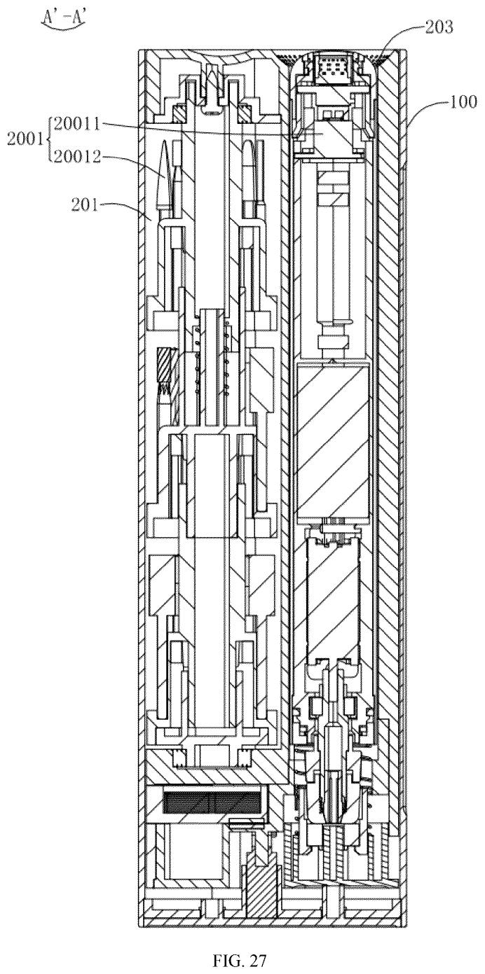

Referring to FIGS. 22-24, 27, 30 and 32, in a first embodiment, the storage device 100 may include an outer case 10, an inner case 20, a holding member 30, a first connection mechanism 40, and a second connection mechanism 50. The inner case 20 is detachably received in the outer case 10. The inner case 20 is to receive the first to-be-received members 100p and the second to-be-received member 100m. The first connection mechanism 40 and the second connection mechanism 50 are both received in the outer case 10. The first connection mechanism 40 is used for the detachable connection between the inner case 20 and the outer case 10. The second connection mechanism 50 is used for the detachable connection between either the inner connection mechanism 20 or the outer connection mechanism 10 and the second to-be-received member 100m. The holding member 30 is received in the inner case 20, and is used for holding the first to-be-received members 100p in position. The storage device 100 accommodates the first to-be-received members 100p, which may serve as accessories of an electric tool, thereby significantly enhancing user accessibility when locating/using the first to-be-received members 100p. The storage device 100 accommodates the second to-be-received member 100m, which can be the main body of the electric tool, thereby significantly enhancing user accessibility when operating the second to-be-received member 100m.

The outer case 10 is provided with a chamber 101 and an opening 102 communicating with the chamber 101. The chamber 101 is to receive the inner case 20, the first connection mechanism 40, the second connection mechanism 50, and the holding member 30, the first to-be-received members 100p and the second to-be-received member 100m in the inner case 20.

The inner case 20 can be received in the chamber 101 through the opening 102, and the inner case 20 is detachably connected to the outer case 10 via the first connection mechanism 40. The inner case 20 is to receive the first to-be-received members 100p and/or the second to-be-received member 100m.

The inner case 20 defines a first accommodation chamber 201 and a window 202 in communication with the first accommodation chamber 201. The first accommodation chamber 201 is to house the first holding member 30 that is to hold the first to-be-received members 100p in position. The window 202 is to expose at least a portion of the holding member 30, so that the first to-be-received members 100p secured on the holding member 30 is exposed, which facilitates users to take out the first to-be-received members 100p.

It should be noted that the exposure involved in the embodiment of the present disclosure means that the holding member 30 located at the window 202 can be seen from the outside of the inner case 20. When the first to-be-received members 100p is accommodated in the inner case 20, the exposure involved in the embodiment of the present disclosure also means that the first to-be-received members 100p located at the window 202 can be seen from the outside of the inner case 20.

In one embodiment, the inner case 20 is provided with a second accommodation chamber 203 and a through hole 204 in communication with the second accommodation chamber 203. The second accommodation chamber 203 is to house the second to-be-received member 100m. The through hole 204 allows for the second to-be-received member 100m to be inserted into the second accommodation chamber 203, thereby realizing a detachable connection between the second to-be-received member 100m and either the inner case 20 or the outer case 10.

It should be noted that, in one embodiment, the through hole 204 is exposed at the opening 102. That is, when the inner case 20 is received in the outer case 10, the through hole 204 can be seen at the opening 102.

In one embodiment, the axis of the first accommodation chamber 201 and the axis of the second accommodation chamber 203 are arranged in parallel to each other. The axis of the first accommodation chamber 201 is the center line of the first accommodation chamber 201, and the axis of the second accommodation chamber 203 is the center line of the second accommodation chamber 203.

In one embodiment, the holding member 30 is accommodated in the first accommodation chamber 201, and is movably connected to the inner case 20. The holding member 30 is provided with one or more mounting portions 301, and at least a portion of the one or more mounting portions 301 can be exposed through the window 202 of the inner case 20. The one or more mounting portions 301 are to secure the first to-be-received members 100p in position. The exposure means that at least a portion of the one or more mounting portions 301 can be seen from the window 202 from the outside of the inner case 20. The first to-be-received members 100p are secured by the one or more mounting portions 301 of the holding member 30, thereby improving the accessibility and ease of retrieval of the first to-be-received members 100p.

In one embodiment, the holding member 30 is rotatably connected to the inner case 20, and the number of the mounting portions 301 is multiple, and the multiple mounting portions 301 are distributed along the rotational direction of the holding member 30. Each mounting portion 301 is to store one first to-be-received member 100p, so that multiple first to-be-received members 100p can be stored. In addition, when the holding member 30 is rotated, the multiple mounting portions 301 are alternately exposed to the window 202, which facilitates users to take the first to-be-received members 100p retained by the mounting portions 301.

In one embodiment, the inner case 20 is provided with at least two bearings 21 located in the first accommodation chamber 201. Opposite ends of the holding member 30 along the first direction D1 are arranged on the bearings 21, so as to realize the rotational connection between the holding member 30 and the inner case 20.

In one embodiment, the holding member 30 is retractable along the first direction D1. The holding member 30 includes a first bracket 31, a second elastic member 32, and a second bracket 33 connected in sequence along the first direction D1. The first bracket 31 abuts against the inner case 20, and the second bracket 33 abuts against the inner case 20. The first bracket 31 is provided with a number of the mounting portions 301, and the second bracket 33 is provided with a number of the mounting portions 301.

In one embodiment, the second bracket 33 is partly inserted into the first bracket 31, one end of the second elastic member 32 is connected to an end of the first bracket 31 close to the second bracket 33, and the other end of the second elastic member 32 is connected to an end of the second bracket 33 close to the first bracket 31, so that the first bracket 31 can move relative to the inner case 20 along the first direction D1 or the second bracket 33 can move relative to the inner case 20 along the first direction D1 through the second elastic member 32.

In one embodiment, to enhance user enjoyment when operating the storage device 100, the storage device 100 may produce sound when the holding member 30 is rotated. The holding member 30 is provided with a first engaging member 302, while the inner case 20 includes a first elastic member 22 and a second engaging member 23. The first elastic member 22 is connected to the inner case 20, and the second engaging member 23 is attached to the end of the first elastic member 22 away from the inner case 20. The second engaging member 23 is designed to engage with the first engaging member 302. When the holding member 30 rotates relative to the inner case 20, the first engaging member 302 periodically pushes the second engaging member 23 to move toward the first elastic member 22, causing the first elastic member 22 to alternately compress, stretch, or return to its original length. As a result, the first elastic member 22 drives the second engaging member 23 to move away from the first engaging member 302 (when compressed) and toward the first engaging member 302 (when released). This cyclic interaction causes repeated collisions between the first engaging member 302 and the second engaging member 23, generating audible clicks or sounds for user feedback.

In one embodiment, both the first engaging member 302 and the second engaging member 23 are made of metal, which facilitates sound generation when they collide.

In one embodiment, the first engaging member 302 may include a main body 3021, multiple protrusions 3022, and multiple recesses 3023. Each recess 3023 is formed between two adjacent protrusions 3022. These protrusions and recesses are arranged along the rotational direction of the holding member on the main body 3021. When the second engaging member 23 contacts a protrusion 3022, the first elastic member 22 drives the second engaging member 23 away from the first engaging member 302. When the second engaging member 23 aligns with a recess 3023, it moves toward the first engaging member 302 under elastic force. This cyclic interaction causes the second engaging member 23 to alternately collide with the protrusions 3022 and recesses 3023, generating audible feedback (e.g., clicks) during rotation.

In one embodiment, the first connection mechanism 40 is disposed in the chamber 101, and the inner case 20 is detachably connected to the first connection mechanism 40. The second connection mechanism 50 is disposed in the chamber 101, and the second switch 50 functions to detachably connect either the inner case 20 or the outer case 10 to the second to-be-received member 100m.

In one embodiment, the first connection mechanism 40 is a push latch 40 that is disposed at the bottom of the chamber 101. Specifically, the inner case 20 can enter the chamber 101 of the outer case 10 from the opening 102 of the outer case 10 until it reaches the bottom of the chamber 101, and is locked by the first connection mechanism 40. The inner case 20 is provided with a connecting portion 24, and the connecting portion 24 is detachably connected to the push latch 401. That is, the inner case 20 and the first connection mechanism 40 are locked and unlocked by the connecting portion 24 of the inner case 20. Specifically, by pressing the inner case 20, the inner case 20 can be locked to the first connection mechanism 40, and by pressing the inner case 20 again, the inner case 20 can be unlocked from the first connection mechanism 40.

In one embodiment, the second connection mechanism 50 may include an unlocking member 501, which is disposed at the bottom of the chamber 101. The inner case 20 is provided with a movable member 25 at its end facing the second connection mechanism 50, and the unlocking member 501 can act on the movable member 25. The movable member 25 is detachably connected to the second to-be-received member 100m. Through the unlocking member 501 and the movable member 25 provided in the inner case 20, the second connection mechanism 50 can unlock and lock the second to-be-received member 100m, the inner case 20 or the outer case 10.

In one embodiment, the inner case 20 is provided with a first elastic member 26 and a magnetic member 27. Under the abutment of the unlocking member 501, the movable element 25 can move relative to the inner case 20 along the first direction D1 or the second direction D2 through the mounting hole 205. The first elastic member 26 extends along the first direction D1. The initial state of the first elastic member 26 is not specifically limited. One end of the first elastic member 26 is connected to the inner case 20, and the other end of the first elastic member 26 is connected with the second to-be-received member 100m. The magnetic member 27 is provided in the second accommodation chamber 203, and the magnetic member 27 is to connect with the second to-be-received member 100m by magnetic attraction. When the inner case 20 is arranged in the outer case 10 and the inner case 20 is pressed along the first direction D1 at the opening 102, the first connection mechanism 40 is switched to an unlock state. The unlocking member 501 acts on the movable member 25, so that the movable member 25 protrudes from the magnetic member 27 along the second direction D2 and acts on the second to-be-received member 100m. The first elastic member 26 stretches or returns to its original length. The first elastic element 26 can drive the second to-be-received member 100m arranged in the second accommodation chamber 203 to move away from the magnetic member 27, and drive the inner case 20 to move away from the bottom of the chamber 101, so as to realize the unlocking of the inner case 20 from the outer case 10, and realize the unlocking of the second to-be-received member 100m from the inner case 20 or the outer case 10. In another scenario, when the inner case 20 is inserted into the chamber 101 through the opening 102 and the inner case 20 is pressed along the first direction D1 at the opening 102, the first connection mechanism 40 is locked. When second to-be-received member 100m is pressed along the first direction D1, the first elastic member 26 is compressed, and the second to-be-received member 100m received in the second accommodation chamber 203 moves toward the magnetic member 27, so that the second to-be-received member 100m is magnetically connected with the magnetic member 27, thereby realizing the separate installation of the inner case 20 and the second to-be-received member 100m. That is, the locking of the inner case 20 to the outer case 10 by the first connection mechanism 40 is realized, and the locking of the second to-be-received member 100m to the inner case 20 is realized.

In one embodiment, the inner case 20 is further provided with a second elastic member 28 located in the second accommodation chamber 203, and the second elastic member 28 extends along the first direction D1. The initial state of the second elastic member 28 is not specifically limited. One end of the second elastic member 28 is connected to the inner case 20, and the other end of the second elastic member 28 is connected with the movable member 25. Through the second elastic member 28, after the second connection mechanism 50 unlocks the second to-be-received member 100m from the inner case 20 or the outer case 10, the movable member 25 is pushed by the second connection mechanism 50 to move along the second direction D2. After the inner case 20 is ejected, the movable member 25 can reset toward the unlocking member 501 under the action of the second elastic member 28, facilitating the next interaction between the unlocking member 501 and the movable member 25. This allows the unlocking member 501 to disengage the second to-be-received member 100m from the inner case 20 or the outer case 10. Specifically, when the inner case 20 is arranged in the outer case 10, and the inner case 20 is pressed along the first direction D1 at the opening 102, the first connection mechanism 40 is unlocked. The unlocking member 501 acts on the movable member 25 to make the movable member 25 protrude from the magnetic member 27 along the second direction D2. The first elastic member 26 stretches or returns to its original length, and the second elastic member 28 stretches or returns to its original length. The first elastic member 26 drives the second to-be-received member 100m arranged in the second accommodation chamber 203 to move away from the magnetic member 27, and the inner case 20 moves away from the bottom of the chamber 101, thereby realizing the unlocking of the inner case 20 from the outer case 10, and at the same time realizing the unlocking of the second to-be-received member 100m from the inner case 20 or the outer case 10. At this time, the second elastic member 28 drives the movable member 25 to reset toward the unlocking member 501. When the inner case 20 is received in the chamber 101 from the opening 102 and the inner case 20 is pressed along the first direction D1 at the opening 102, the first connection mechanism 40 is locked to secure the inner case 20 in the outer case 10. Additionally, when the second to-be-received member 100m is pressed along the first direction D1, the first elastic member 26 is compressed, and the second to-be-received member 100m moves toward the magnetic member 27, so that the second to-be-received member 100m is magnetically connected with the magnetic member 27.

It should be noted that when the second connection mechanism 50 unlocks the second to-be-received member 100m, the movable member 25 plays an important role. One implementation of the movable member 25 is that the movable member 25 includes a contact member 251, a sliding member 252, a pushing member 253 and an assembly member 254. The sliding member 252, the pushing member 253 and the assembly member 254 are arranged on the contact member 251, and the contact member 251 functions to contact the unlocking member 501. The sliding member 252 is arranged on the side of the contact member 251 facing away from the unlocking member 501, and one end of the sliding member 252 away from the contact member 251 is received in the inner case 20. The sliding member 252 can move relative to the inner case 20 along the first direction D1. The pushing member 253 and the assembly member 254 are both arranged on the side of the contact member 251 facing away from the unlocking member 501. The magnetic member 27 is provided with a sliding hole 271, and the end of the pushing member 253 away from the contact member 251 is inserted into the sliding hole 271. The pushing member 253 can move relative to the magnetic member 27 along the first direction D1, and the assembly member 254 is to connect with the other end of the second elastic element 28.

In one embodiment, the second to-be-received member 100m is provided with a receiving hole 100m1 for receiving the second to-be-received member 100m. When the second to-be-received member 100m is arranged in the second accommodation chamber 203, the center line of the receiving hole 100m1 coincides with the center line of the sliding hole 271. The diameter of the sliding hole 271 is larger than the diameter of the receiving hole 100m1, so that the pushing member 253 of the movable member 25 can avoid the receiving hole 100m1, which can prevent the pushing member 253 from rubbing against the receiving hole 100m1 and damaging the second to-be-received member 100m. When the movable member 25 protrudes from the magnetic member 27 along the second direction D2, the pushing member 253 can act on the second to-be-received member 100m, so that the second to-be-received member 100m arranged in the second accommodation chamber 203 moves away from the magnetic member 27, and the inner case 20 moves away from the bottom of the chamber.

In another embodiment, the diameter of the sliding hole 271 may be set to be no larger than the diameter of the receiving hole 100m1, and the pushing member 253 pushes against the receiving hole 100m1 to separate the second to-be-received member 100m from the magnetic member 27.

It should be noted that, through the above-mentioned first connection mechanism 40 and second connection mechanism 50, when the inner case 20 is accommodated in the outer case 10, only a single pressing action on the inner case 20 is required to simultaneously unlock the first connection mechanism 40 and unlock the second connection mechanism 50, thereby unlocking the inner case 20 from the outer case 10, and unlocking the second to-be-received member 100m from either the inner case 20 or the outer case 10.

When the inner case 20 and the second to-be-received member 100m need to be stored, the inner case 20 can be inserted into the chamber 101 through the opening 102 and can be pressed. This action will cause the first connection mechanism 40 to be locked, thereby locking the inner case 20 to the outer case 10. Similarly, pressing the second to-be-received member 100m can lock the second to-be-received member 100m to the inner case 20. Thus, the second to-be-received member 100m and the inner case 20 can be stored separately, which can better meet the user's needs. For example, after the user removes one or more first to-be-received members 100p from the inner case 20, they can store the inner case 20 inside the outer case 10 to prevent the remaining first to-be-received members 100p from being lost. After the second to-be-received member 100m is used, the second to-be-received member 100m can be stored in the inner case 20. Compared to conventional storage devices where the second to-be-received member is snap-fitted into the inner case, the configuration of storage device of the present disclosure can avoid the first to-be-received member 100p from being disengaged from the holding member 30 by accidentally touching the first to-be-received member 100m when installing the second to-be-received member 100m, and the press-to-lock mechanism offers a more convenient and simpler operation.

The storage device 100 of the present disclosure allows for independent storage of the inner case 20 and the second to-be-received member 100m. For example, if the user frequently needs to access one or more first to-be-received members 100p, storing the inner case 20 inside the outer case 10 may cause inconvenience. To facilitate easier access to both the first to-be-received members 100p and the second to-be-received member 100m, the storage device 100 enables the installation and detachment of the second to-be-received member 100m from the inner case 20 without requiring a second connection mechanism 50. When the user needs to detach the second to-be-received member 100m from the inner case 20, they can manually press the contact member 251, compressing the second elastic member 28 and causing the pushing member 253 to push against the second to-be-received member 100m. This action separates the second to-be-received member 100m from the magnetic member 27, allowing the user to easily remove it from the inner case 20.

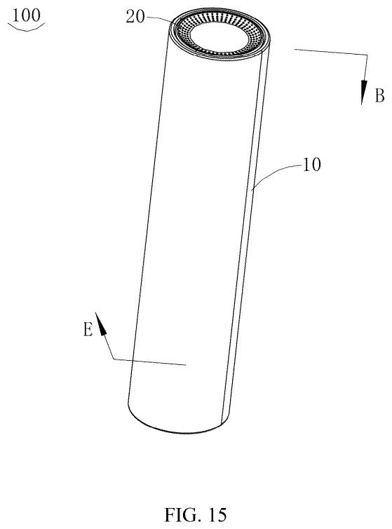

Referring to FIGS. 15, 18 and 21, in a second embodiment, the storage device 100 may include an outer case 10, an inner case 20, a holding member 30, and a first connection mechanism 40. The inner case 20 is detachably received in the outer case 10. The inner case 20 is to receive one or more first to-be-received members 100p. The first connection mechanism 40 is received in the outer case 10. The first connection mechanism 40 is to detachably connect the inner case 20 to the outer case 10. The holding member 30 is received in the inner case 20, and is to hold the one or more first to-be-received members 100p in position. The storage device 100 accommodates the first to-be-received members 100p, which may serve as accessories of an electric tool, thereby significantly enhancing user accessibility when locating/using the first to-be-received members 100p.

The outer case 10 is provided with a chamber 101 and an opening 102 communicating with the chamber 101. The chamber 101 is to receive the inner case 20, the first connection mechanism 40, and the holding member 30 and the first to-be-received members 100p in the inner case 20.

The inner case 20 can be received in the chamber 101 through the opening 102, and the inner case 20 is detachably connected to the outer case 10 via the first connection mechanism 40. The inner case 20 is to receive the first to-be-received members 100p.

The inner case 20 defines a first accommodation chamber 201 and a window 202 in communication with the first accommodation chamber 201. The first accommodation chamber 201 is to house the first holding member 30 that is to hold the first to-be-received members 100p in position. The window 202 is to expose at least a portion of the holding member 30, so that the first to-be-received members 100p secured on the holding member 30 is exposed, which facilitates users to take out the first to-be-received members 100p.

It should be noted that the exposure involved in the embodiment of the present disclosure means that the holding member 30 located at the window 202 can be seen from the outside of the inner case 20. When the first to-be-received members 100p is accommodated in the inner case 20, the exposure involved in the embodiment of the present disclosure also means that the first to-be-received members 100p located at the window 202 can be seen from the outside of the inner case 20.

In one embodiment, the holding member 30 is accommodated in the first accommodation chamber 201, and is movably connected to the inner case 20. The holding member 30 is provided with one or more mounting portions 301, and at least a portion of the one or more mounting portions 301 can be exposed through the window 202 of the inner case 20. The one or more mounting portions 301 are to secure the first to-be-received members 100p in position. The exposure means that at least a portion of the one or more mounting portions 301 can be seen from the window 202 from the outside of the inner case 20. The first to-be-received members 100p are secured by the one or more mounting portions 301 of the holding member 30, thereby improving the accessibility and ease of retrieval of the first to-be-received members 100p.

In one embodiment, the holding member 30 is rotatably connected to the inner case 20, and the number of the mounting portions 301 is multiple, and the multiple mounting portions 301 are distributed along the rotational direction of the holding member 30. Each mounting portion 301 is to store one first to-be-received member 100p, so that multiple first to-be-received members 100p can be stored. In addition, when the holding member 30 is rotated, the multiple mounting portions 301 are alternately exposed to the window 202, which facilitates users to take out the first to-be-received members 100p retained by the mounting portions 301.

In one embodiment, the inner case 20 is provided with at least two bearings 21 located in the first accommodation chamber 201. Opposite ends of the holding member 30 along the first direction D1 are arranged on the bearings 21, so as to realize the rotational connection between the holding member 30 and the inner case 20.

In one embodiment, to enhance user enjoyment when operating the storage device 100, the storage device 100 may produce sound when the holding member 30 is rotated. The holding member 30 is provided with a first engaging member 302, while the inner case 20 includes a first elastic member 22 and a second engaging member 23. The first elastic member 22 is connected to the inner case 20, and the second engaging member 23 is attached to the end of the first elastic member 22 away from the inner case 20. The second engaging member 23 is designed to engage with the first engaging member 302. When the holding member 30 rotates relative to the inner case 20, the first engaging member 302 periodically pushes the second engaging member 23 to move toward the first elastic member 22, causing the first elastic member 22 to alternately compress, stretch, or return to its original length. As a result, the first elastic member 22 drives the second engaging member 23 to move away from the first engaging member 302 (when compressed) and toward the first engaging member 302 (when released). This cyclic interaction causes repeated collisions between the first engaging member 302 and the second engaging member 23, generating audible clicks or sounds for user feedback.

In one embodiment, both the first engaging member 302 and the second engaging member 23 are made of metal, which facilitates sound generation when they collide.

In one embodiment, the first engaging member 302 may include a main body 3021, multiple protrusions 3022, and multiple recesses 3023. Each recess 3023 is formed between two adjacent protrusions 3022. These protrusions and recesses are arranged along the rotational direction of the holding member on the main body 3021. When the second engaging member 23 contacts a protrusion 3022, the first elastic member 22 drives the second engaging member 23 away from the first engaging member 302. When the second engaging member 23 aligns with a recess 3023, it moves toward the first engaging member 302 under elastic force. This cyclic interaction causes the second engaging member 23 to alternately collide with the protrusions 3022 and recesses 3023, generating audible feedback (e.g., clicks) during rotation.

Regarding the first connection mechanism 40, the first connection mechanism 40 is disposed in the chamber 101, and the inner case 20 is detachably connected to the first connection mechanism 40.

In one embodiment, the first connection mechanism 40 is a push latch 40 that is disposed at the bottom of the chamber 101. Specifically, the inner case 20 can enter the chamber 101 of the outer case 10 from the opening 102 of the outer case 10 until it reaches the bottom of the chamber 101, and is locked by the first connection mechanism 40. The inner case 20 is provided with a connecting portion 24, and the connecting portion 24 is detachably connected to the push latch 401. That is, the inner case 20 and the first connection mechanism 40 are locked and unlocked by the connecting portion 24 of the inner case 20. Specifically, by pressing the inner case 20, the inner case 20 can be locked to the first connection mechanism 40, and by pressing the inner case 20 again, the inner case 20 can be unlocked from the first connection mechanism 40.

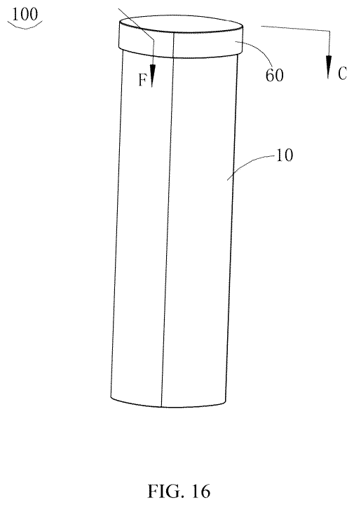

Referring to FIGS. 16, 19, 24 and 25, in a third embodiment, the storage device 100 may include an outer case 10, an inner case 20, a holding member 30, and a first connection mechanism 40, a second connection mechanism 50, and an upper cover 60. The inner case 20 is detachably received in the outer case 10. The inner case 20 is to receive one or more first to-be-received members 100p and the second to-be-received member 100m. The first connection mechanism 40 and the second connection mechanism 50 are both received in the outer case 10. The first connection mechanism 40 is used for the detachable connection between the inner case 20 and the outer case 10. The second connection mechanism 50 is used for the detachable connection between either the inner connection mechanism 20 or the outer connection mechanism 10 and the second to-be-received member 100m. The holding member 30 is received in the inner case 20, and is used for holding the first to-be-received members 100p in position. The upper cover 60 is arranged on the outer case 10. The storage device 100 accommodates the first to-be-received members 100p, which may serve as accessories of an electric tool, thereby significantly enhancing user accessibility when locating/using the first to-be-received members 100p. The storage device 100 accommodates the second to-be-received member 100m, which can be the main body of the electric tool, thereby significantly enhancing user accessibility when operating the second to-be-received member 100m.

In one embodiment, the outer case 10 is provided with a chamber 101 and an opening 102 in communication with the chamber 101. The chamber 101 is to receive the inner case 20, the first connection mechanism 40, the second connection mechanism 50, and the holding member 30, the first to-be-received members 100p and the second to-be-received member 100m in the inner case 20. The upper cover 60 covers the opening 102.

The inner case 20 can be received in the chamber 101 through the opening 102, and the inner case 20 is detachably connected to the outer case 10 via the first connection mechanism 40. The inner case 20 is to receive the first to-be-received members 100p and/or the second to-be-received member 100m.

The inner case 20 defines a first accommodation chamber 201 and a window 202 in communication with the first accommodation chamber 201. The first accommodation chamber 201 is to house the first holding member 30 that is to hold the first to-be-received members 100p in position. The window 202 is to expose at least a portion of the holding member 30, so that the first to-be-received members 100p secured on the holding member 30 are exposed, which facilitates users to take out the first to-be-received members 100p.

It should be noted that the exposure involved in the embodiment of the present disclosure means that the holding member 30 located at the window 202 can be seen from the outside of the inner case 20. When the first to-be-received members 100p is accommodated in the inner case 20, the exposure involved in the embodiment of the present disclosure also means that the first to-be-received members 100p located at the window 202 can be seen from the outside of the inner case 20.

In one embodiment, the inner case 20 is provided with a second accommodation chamber 203 and a through hole 204 in communication with the second accommodation chamber 203. The second accommodation chamber 203 is to house the second to-be-received member 100m. The through hole 204 allows for the second to-be-received member 100m to be inserted into the second accommodation chamber 203, thereby realizing a detachable connection between the second to-be-received member 100m and either the inner case 20 or the outer case 10.

It should be noted that, in one embodiment, the through hole 204 is exposed at the opening 102. That is, when the inner case 20 is received in the outer case 10, the through hole 204 can be seen at the opening 102.

In one embodiment, the first accommodation chamber 201 and the second accommodation chamber 203 are arranged coaxially, which means that the center line of the first accommodation chamber 201 and the center line of the second accommodation chamber 203 coincide.

In one embodiment, the holding member 30 is accommodated in the first accommodation chamber 201. The holding member 30 is provided with one or more mounting portions 301, and at least a portion of the one or more mounting portions 301 can be exposed through the window 202 of the inner case 20. The one or more mounting portions 301 are to secure the first to-be-received members 100p in position. The exposure means that at least a portion of the one or more mounting portions 301 can be seen from the window 202 from the outside of the inner case 20. The first to-be-received members 100p are secured by the one or more mounting portions 301 of the holding member 30, thereby improving the accessibility and ease of retrieval of the first to-be-received members 100p.

In one embodiment, multiple mounting portions 301 are employed, and the multiple mounting portions 301 are arranged around the holding member 30. Each mounting portion 301 is to store one first to-be-received member 100p, so that multiple first to-be-received members 100p can be stored.

In one embodiment, the first connection mechanism 40 is disposed in the chamber 101, and the inner case 20 is detachably connected to the first connection mechanism 40. The second connection mechanism 50 is disposed in the chamber 101, and the second switch 50 functions to detachably connect either the inner case 20 or the outer case 10 to the second to-be-received member 100m.

In one embodiment, the first connection mechanism 40 includes a first mounting member 41a, a first elastic connecting member 42a, a first magnetic member 43a and a first fastener 44a. The first mounting member 41a, the first elastic connecting member 42a and the first magnetic member 43a are connected in sequence. The first mounting member 41a is arranged at the bottom of the chamber 101. The first magnetic member 43a can be magnetically connected to the inner case 20. One end of the first fastener 44a is arranged on the first magnetic member 43a, and the other end of the first fastener 44a is engaged with the first mounting member 41a. When the first magnetic member 43a moves relative to the first mounting member 41a through the first elastic connecting member 42a, the first fastener 44a moves in the same direction as the first magnetic member 43a relative to the first mounting member 41a. When the inner case 20 is accommodated in the outer case 10, by pressing the inner case 20, the first elastic connecting member 42a stretches or returns to its original length, thereby driving the inner case 20 to be disengaged from the outer case 10. In another scenario, after the inner case 20 enters the chamber 101 from the opening 102, by pressing the inner case 20, the first elastic connecting member 42a is reset or compressed, so that the inner case 20 contacts with the first magnetic member 43a, realizing the magnetic connection between the inner case 20 and the first magnetic member 43a, that is, realizing the detachable connection between the inner case 20 and the outer case 10 through the first connection mechanism 40.

In addition, through the first fastener 44a, when the inner case 20 is accommodated in the outer case 10, by pressing the inner case 20, the first fastener 44a limits the distance over which the first elastic connecting member 42a drives the first magnetic member 43a to move relative to the first mounting member 41a, so that when the inner case 20 enters the chamber 101 from the opening 102, it is convenient for the first elastic connecting member 42a to be reset or compressed, so as to realize the magnetic connection between the inner case 20 and the first magnetic member 43a.

It should be noted that one end of the first fastener 44a is disposed on the first magnetic member 43a. In one embodiment, the end of the first fastener 44a can be fixed to the first magnetic member 43a. In another embodiment, the end of the first fastener 44a can be integrally formed with the first magnetic member 43a. In yet another embodiment, the end of the first fastener 44a can be inserted into the first magnetic member 43a. The other end of the first fastener 44a is engaged with the first mounting member 41a. When the first magnetic member 43a moves relative to the first mounting member 41a through the first elastic connecting member 42a, the first fastener 44a moves in the same direction as the first magnetic member 43a relative to the first mounting member 41a. The first mounting member 41a is provided with a first sliding groove 411a and a first limiting member 412a. The first sliding groove 411a is arranged around the first limiting member 412a. The first sliding groove 411a has a first position 4111a close to the first magnetic member 43a. The first limiting member 412a is provided with a first limiting portion 4121a. The first limiting portion 4121a is arranged away from the first magnetic member 43a. When the inner case 20 is received in the outer case 10, the other end of the first fastener 44a is engaged with the first limiting portion 4121a. When the inner case 20 is pressed, the first elastic connecting member 42a is first compressed. The other end of the first fastener 44a is away from the first limiting portion 4121a, and the other end of the first fastener 44a is free from the restriction of the first limiting portion 4121a. The first elastic connecting member 42a stretches or returns to its original length, so that the other end of the first fastener 44a slides along the first sliding groove 411a to the first position 4111a, thereby driving the inner case 20 to be disengaged from the outer case 10. In another scenario, when the inner case 20 enters the chamber 101 from the opening 102, by pressing the inner case 20, the first elastic connecting member 42a is reset or compressed, and the other end of the first fastener 44a slides along the first sliding groove 411a to the first limiting portion 4121a, so that the inner case 20 is magnetically connected with the first magnetic member 43a.

In one embodiment, the second connection mechanism 50 includes a second mounting member 51a, a second elastic connecting member 52a, a second magnetic member 53a and a second fastener 54a. The second mounting member 51a, the second elastic connecting member 52a and the second magnetic member 53a are connected in sequence. The second mounting member 51a is arranged at the bottom of the chamber 101. One end of the second magnetic member 53a away from the bottom of the chamber 101 extends from the mounting hole 205 of the inner case 20 to the second accommodation chamber 203. The second magnetic member 53a can be magnetically connected with the second to-be-received member 100m. One end of the second fastener 54a is arranged on the second magnetic member 53a, and the other end of the second fastener 54a is connected with the second mounting member 51a. When the second magnetic member 53a moves relative to the second mounting member 51a through the second elastic connecting member 52a, the second fastener 54a moves in the same direction relative to the second mounting member 51a as the second magnetic member 53a. When the inner case 20 is accommodated in the outer case 10, by pressing the inner case 20 or the second to-be-received member 100m, the second elastic connecting member 52a is stretched or restored to its original length, thereby driving the second to-be-received member 100m to be disengaged from the inner case 20 or the outer case 10. In another scenario, after the second to-be-received member 100m enters the second accommodation chamber 203, by pressing the inner case 20 or the second to-be-received member 100m, the second elastic connecting member 52a is reset or compressed, so that the second to-be-received member 100m contacts the second magnetic member 53a, thereby realizing the magnetic connection between the second to-be-received member 100m and the second magnetic member 53a. That is, the detachable connection between the second to-be-received member 100m and either the inner case 20 or the outer case 10 is realized through the second connection mechanism 50.

In addition, through the second fastener 54a, when the inner case 20 is accommodated in the outer case 10, by pressing the inner case 20, the second fastener 54a limits the distance over which the second elastic connecting member 52a drives the second magnetic member 53a to move relative to the second mounting member 51a, so that when the second to-be-received member 100m enters the second accommodation chamber 203, it is convenient for the second elastic connecting member 52a to be reset or compressed, so as to realize the detachable connection between the second to-be-received member 100m and the inner case 20 or the outer case 10.

It should be noted that one end of the second fastener 54a is disposed on the second magnetic member 53a. In one embodiment, the end of the second fastener 54a can be fixed to the second magnetic member 53a. In another embodiment, the end of the second fastener 54a can be integrally formed with the second magnetic member 53a. In yet another embodiment, the end of the second fastener 54a can be inserted into the second magnetic member 53a. The other end of the second fastener 54a is engaged with the second mounting member 51a. When the second magnetic member 53a moves relative to the second mounting member 51a through the second elastic connecting member 52a, the second fastener 54a moves in the same direction as the second magnetic member 53a relative to the second mounting member 51a. The other end of the second fastener 54a can be connected with the second mounting member 51a in a manner as follows. Specifically, the second mounting member 51a is provided with a second sliding groove (not shown) and a second limiting member (not shown). The second sliding groove is arranged around the second limiting member. The second sliding groove has a second position close to the second magnetic member 53a. The second limiting member is provided with a second limiting portion, and the second limiting portion is arranged away from the second magnetic member 53a. When the second to-be-received member 100m is accommodated in the second accommodation chamber 203 of the inner case 20, the other end of the second fastener 54a is engaged with the second limiting portion. When the inner case 20 or the second to-be-received member 100m is pressed, the second elastic connecting member 52a is first compressed. The other end of the second fastener 54a is away from the second limiting portion, and the other end of the second fastener 54a is free from the restriction of the second limiting portion. The second elastic connecting member 52a stretches or returns to its original length, so that the other end of the second fastener 54a slides along the second sliding groove to the second position, so that the second to-be-received member 100m is disengaged from the inner case 20 or the outer case 10. In another scenario, when the second to-be-received member 100m enters the second accommodation chamber 203, the second elastic connecting member 52a can be reset or compressed by pressing the inner case 20 or the second to-be-received member 100m, and the other end of the second fastener 54a slides along the second sliding groove to the second limiting portion, thereby realizing the magnetic connection between the second to-be-received member 100m and the second magnetic member 53a.

It should be noted that, through the above-mentioned first connection mechanism 40 and second connection mechanism 50, when the inner case 20 is accommodated in the outer case 10, only a single pressing action on the inner case 20 is required to simultaneously unlock the first connection mechanism 40 and unlock the second connection mechanism 50, thereby unlocking the inner case 20 from the outer case 10, and unlocking the second to-be-received member 100m from either the inner case 20 or the outer case 10.

In a fourth embodiment, the storage device 100 may include an outer case 10, an inner case 20, and a second connection mechanism 50. The second connection mechanism 50 is to detachably connect the second to-be-received member 100m to the inner case 20.

In a fifth embodiment, the storage device 100 may include an outer case 10, an inner case 20, and a first connection mechanism 40. The first connection mechanism 40 is to detachably connect the inner case 20 to the outer case 10. The second to-be-received member 100m may be freely received in the inner case without any restrictions. Alternatively, the second to-be-received member 100m may be detachably connected to the inner case by a snap-fit connection mechanism.

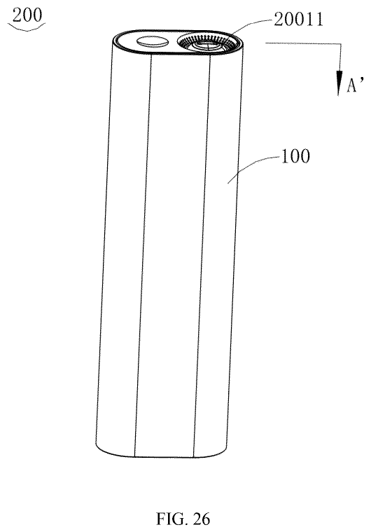

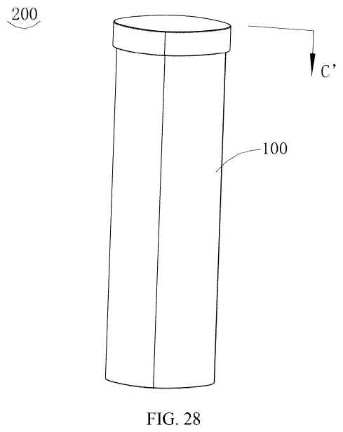

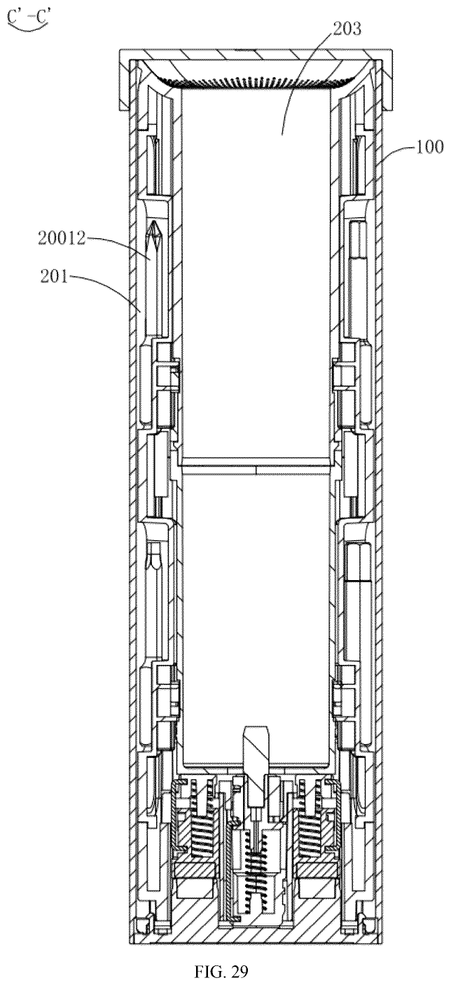

Referring to FIGS. 26-29, in one embodiment, an electric tool assembly includes an electric tool 2001 and the storage device 100. The storage device 100 is to store the main body 20011 of the electric tool 2001 and accessories 20012 of the electric tool. The accessories 20012 are stored in the first accommodation chamber 201, and the main body 20011 is stored in the second accommodation chamber 203. The specific structure and functions of the storage device 100 can be referred to in the above-mentioned embodiments and will not be repeated here.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An electric tool comprising:
a housing assembly comprising a housing body and an operation portion integrally connected with the housing body;
a driving mechanism connected to the housing assembly and comprising a motor and a transmission shaft connected to and driven by the motor; and
a control module arranged within the housing assembly and comprising a controller and a sensing element that is electrically connected to the controller; wherein the motor is electrically connected to the controller, the sensing element is arranged at an inner side of the operation portion, the sensing element is configured to detect a user operation on the operation portion and output a signal to the controller, and the controller is configured to control the motor in response to the signal output by the sensing element.

2. The electric tool of claim 1, further comprising a light-emitting module that comprises one or more light-emitting elements, wherein the one or more light-emitting elements are electrically connected to the controller; the controller is further configured to adjust one or more light-emitting parameters of the one or more light-emitting elements according to a rotational speed of the transmission shaft.

3. The electric tool of claim 2, wherein a number of the one or more light-emitting elements is one, and the light-emitting element is a light strip; the light strip is configured to have an illumination length that is adjustable according to the rotational speed of the transmission shaft.

4. The electric tool of claim 1, further comprising a battery and a switch mechanism, wherein the switch mechanism comprises a movable member that is movably connected to the housing assembly; the movable member is movable to a first position and a second position relative to the housing assembly; when the movable member moves to the first position, the battery is electrically connected to the controller, thereby activating the motor; when the movable member moves to the second position, the controller is disconnected from the battery, thereby deactivating the motor; during a movement of the movable member from the first position to the second position, a rotational speed of the transmission shaft decreases.

5. The electric tool of claim 1, further comprising a switch mechanism, wherein the switch mechanism comprises a movable member that is movably connected to the housing assembly, the movable member is movable to a first position and a second position relative to the housing assembly; in response to the movable member moving between the first position and the second position, the controller is configured to adjust a rotational speed of the transmission shaft accordingly.

6. The electric tool of claim 5, wherein the movable member is rotatably connected to the housing body, and the controller is further configured to activate or deactivate the motor in response to the signal from the sensing element.

7. The electric tool of claim 4, further comprising a charging module arranged in the housing assembly, wherein the charging module comprises a charging port, the charging port is located on the housing body, and the charging port is electrically connected to the battery through the controller.

8. The electric tool of claim 1, further comprising a limiting mechanism with a first operational state and a second operational state, wherein the transmission shaft is rotatable when the limiting mechanism is in the first operational state, and the transmission shaft is nonrotatable when the limiting mechanism is in the second operational state.

9. The electric tool of claim 8, wherein the limiting mechanism comprises a stopper pin, a spring, and a button, the stopper pin is connected to the button via the spring, the button is movably connected to the housing body, a protrusion is formed on a lateral surface of the button, the transmission shaft is provided with a limit portion; when the limiting mechanism is in the first operational state, the protrusion abuts against the housing body, and the stopper pin is disengaged from the limit portion; when the limiting mechanism is in the second operational state, the limit portion is away from the housing body, and the stopper pin is engaged with the limit portion.

10. The electric tool of claim 1, wherein the operation portion comprises an outer side that is opposite to inner side, and is recessed formed from the outer side toward the inner side.

11. The electric tool of claim 1, wherein the sensing element comprises: a pressure sensor that is configured to detect a pressure exerted on the operation portion; or a temperature sensor that is configured to measure a temperature of the operation portion.

12. The electric tool of claim 1, further comprising a functional module and a locking module, wherein the functional module is detachably connected to the transmission shaft via the locking module.

13. The electric tool of claim 12, wherein the locking module comprises a holder and a locking cap that is arranged around the holder, the locking cap has a locking position and an unlocking position relative to the holder, the locking cap defines a locking hole, the transmission shaft is threadedly connected to the locking hole, the holder comprises a clamping member and a connection member, the transmission shaft defines a shaft hole, and the connection member is connected to the shaft hole, and the clamping member defines a slit; when the locking cap is in the locking position, the slit narrows, thereby enabling the clamping member to grip the functional module; and when the locking cap is in the unlocking position, the slit widens, thereby allowing the clamping member to release the functional module.

14. The electric tool of claim 12, further comprising an identification module, wherein the functional module is electrically connected to the control module via the identification module, the identification module is configured to output a resistance of the functional module to the controller, and the controller is configured to adjust an output speed of the motor based on the resistance.

15. The electric tool of claim 14, wherein the identification module comprises a conductive ring and at least two conductive contacts, the conductive ring is disposed at an end of the functional module adjacent to the transmission shaft, the at least two conductive contacts are spaced apart from each other on the conductive ring, the conductive ring is electrically connected to the controller via the at least two conductive contacts, and is configured to detect a resistance signal of the functional module, and the at least two conductive contacts are configured to transmit the resistance signal to the controller.

16. An electric tool, comprising:
a housing assembly;
a driving mechanism connected to the housing assembly and comprising a motor and a transmission shaft connected to and driven by the motor;
a controller arranged within the housing assembly;
a movable member rotatably connected to the housing assembly;
a switch arranged within the housing assembly and electrically connected to the controller;
a sensing element arranged within the housing assembly and at an inner side of the movable member, wherein the sensing element is electrically connected to the controller, the sensing element is configured to detect a user operation on the movable member and send a signal to the controller, the controller is configured to, in response to the signal from the sensing element, control the motor to perform a first operation, and the controller is further configured to, in response to a triggering of the switch, control the motor to perform a second operation.

17. The electric tool of claim 16, wherein the switch is a press-type switch.

18. The electric tool of claim 16, wherein the sensing element is a rotary potentiometer and comprises a sensor body and a handle rotatably connected to the sensor body, the movable member is rotatably connected to the housing assembly and comprises a handle engagement portion that is engaged with the handle, allowing the handle to rotate when actuated by the movable member, thereby altering an internal resistance of the sensing element, and the controller is configured to, in response to a change in the internal resistance of the sensing element, control the motor to perform the first operation.

19. A storage device for storing an electric tool that comprises a main body and one or more accessories, the storage device comprising:
an outer case defining a chamber and an opening in communication with the chamber;
an inner case insertable into the chamber through the opening, the inner case defining a first accommodation chamber and a second accommodation chamber, the first accommodation chamber configured to receive the one or more accessories, and the second accommodation chamber configured to receive the main body of the electric tool;
a first connection mechanism arranged within the chamber of the outer case; wherein inner case is detachably connected to the first connection mechanism; and
a second connection mechanism arranged within the chamber of the outer case, the second connection mechanism configured to detachably connect the outer case or the inner case to the main body of the electric tool.

20. The storage device of claim 19, further comprising a holding member rotatably received in the first accommodation chamber of the inner case, wherein the holding member is configured to hold the one or more accessories in position.
